(19) United States
(12) Patent Application Publication
(10) Pub. No.: US 2024/0279984 A1
(43) Pub. Date: Aug. 22, 2024

(54) INTEGRATED PLEATED SCREEN ASSEMBLY

(71) Applicant: Pella Corporation, Pella, IA (US)

(72) Inventors: Evan Vande Haar, Pella, IA (US); Todd A. Bernhagen, Pella, IA (US); William R. Parcells, Des Moines, IA (US)

(73) Assignee: Pella Corporation, Pella, IA (US)

(21) Appl. No.: 18/653,074

(22) Filed: May 2, 2024

Related U.S. Application Data
(62) Division of application No. 17/162,402, filed on Jan. 29, 2021, now Pat. No. 12,000,208.
(60) Provisional application No. 63/039,359, filed on Jun. 15, 2020.
(60) Provisional application No. 62/968,403, filed on Jan. 31, 2020.

(51) Int. Cl. E06B 9/262; E06B 7/03; E06B 9/52

(52) U.S. Cl. CPC E06B 9/262; E06B 7/03; E06B 9/52; E06B 2009/2625

(57) ABSTRACT

A screen assembly used with a fenestration unit, the screen assembly capable of being installed at manufacture or retroactively to fenestration units. The screen assembly is installable on a fenestration unit having a frame and a window sash. The screen assembly includes a housing having a first housing member and a second housing member, wherein the housing forms a screen retention space between the first and second housing members when the screen assembly is in a closed position. It further includes a pleated screen positioned between the first and second housing members when the screen assembly is in the closed position, wherein the pleated screen includes a first end coupled to the first housing member and a second end coupled to the second housing member. The screen assembly also includes a catch element configured to releasably engage with the window sash.

### CROSS REFERENCE TO RELATED APPLICATIONS

The present application claims the benefit of U.S. Provisional Patent Application No. 63/039,359, filed Jun. 15, 2020, and U.S. Provisional Patent Application No. 62/968,403, filed Jan. 31, 2020, both of which are incorporated herein by reference in their entirety.

### TECHNICAL FIELD

The present description relates generally to fenestration assemblies, systems and methods. Specifically, the description relates to fenestration assemblies including screen assemblies.

### BACKGROUND

Fenestration assemblies that include moveable glass panels can also include a screen mounted in a fixed position to keep out insects or other pests, more colloquially known as “bugs.” In some cases, the screen can be removed when not needed. However, in both cases, when screen is installed, viewing through at least one of the glass panels includes viewing through the screen, somewhat obscuring the view through the glass panel. Over time the screen can be continuously exposed to the elements, leading to an accumulation of airborne detritus on the screen, further obscuring the view.

Various screens have been described, including in U.S. Pat. No. 7,819,167 to Morin issued Oct. 26, 2010, which relates to a window assembly including a window frame, a pair of spaced-apart guide tracks, at least one window sash mounted to and positioned between the a pair of spaced-apart guide tracks, and a foldable and spreadable pleated screen. The window sash is slidably movable along the guide tracks between an open position and a closed position. The pleated screen has a first screen end mounted to the end of the at least one window sash and a second screen end mounted to a first end of the window frame so that the pleated screen extends when the at least one window sash is in the open position and the pleated screen folds onto itself when the at least one window sash is in the closed position. The pleated screen can also be used in double-hung windows.

However, pleated screens can be aesthetically unpleasing because of the way in which they unravel, can be difficult to manage during use, and can be difficult to install in new or existing fenestration units.

### SUMMARY

Various disclosed concepts relate to a screen assembly, a fenestration unit including a screen assembly, and associated methods. For example, a fenestration unit may include a frame formed by a head, a sill, and two jambs, and a sash formed by a pair of stiles and a pair of rails. The sash is slidably coupled to the frame and is transitionable between open and closed positions. The fenestration unit also includes a screen assembly, the screen assembly in turn including a pleated screen having a first end and a second end, the pleated screen being extendable and retractable between an extended and a retracted state, respectively, a first housing member coupled to the first end of the pleated screen, releasably coupled to the sash, and configured to receive the pleated screen in the retracted state, and a second housing member coupled to the second end of the pleated screen and to the frame.

According to one example (“Example 1”), a screen assembly for a fenestration unit having a frame and a window sash includes a housing having a first housing member and a second housing member, wherein the housing forms a screen retention space between the first and second housing members when the screen assembly is in a closed position; a pleated screen positioned between the first and second housing members when the screen assembly is in the closed position, the pleated screen including a first end coupled to the first housing member and a second end coupled to the second housing member; and a catch element configured to releasably engage with the window sash.

According to another example further to Example 1 (“Example 2”), the screen assembly further includes end caps positioned at first and second longitudinal ends of the housing.

According to another example further to Example 2 (“Example 3”), the end caps include the catch element.

According to another example further to Example 1 (“Example 4”), the housing includes the catch element.

According to another example further to Example 1 (“Example 5”), the screen assembly further includes a pleat restrictor positioned on the housing such that the pleat restrictor extends into the screen retention space.

According to another example further to Example 1 (“Example 6”), the screen assembly further includes a moisture deflector for deflecting moisture away from the screen assembly extending from the housing.

According to another example further to Example 1 (“Example 7”), the screen assembly further including a first cord and a second cord extending from the housing, wherein the first and second cords both extend along a shared length of a longitudinal length of the housing.

According to one example (“Example 8”), a fenestration unit includes a frame having a first portion, a second portion opposite the first portion, a first jamb extending between the first portion and the second portion, and a second jamb opposite the first jamb and extending between the first portion and the second portion, wherein the first jamb and the second jamb each include a first pocket; a sash including a first rail, a second rail opposite the first rail, a first stile extending between the first and second rails, and a second stile opposite the first stile and extending between the first and second rails, wherein the first and second stiles are positioned in the first pocket of the first and second jamb such that the sash is configured to translate within the first pocket relative to the frame; and a screen assembly operable to extend between the first portion of the frame and the first rail of the sash, the screen assembly including a housing having a first housing member and a second housing member, wherein the housing forms a screen retention space between the first and second housing members when the screen assembly is in a closed position, a pleated screen positioned between the first and second housing members when the screen assembly is in the closed position, wherein the pleated screen includes a first end coupled to the first housing member and a second end coupled to the second housing member, and a catch element configured to releasably engage with the first rail of the sash.

According to another example further to Example 8 (“Example 9”), the fenestration unit further includes end caps positioned at first and second longitudinal ends of the housing.

According to another example further to Example 9 (“Example 10”), the fenestration further includes a wash lock extending from the sash, wherein the catch element is positioned on the end caps, and wherein the wash lock is configured to releasably engage the catch element.

According to another example further to Example 10 (“Example 11”), each of the end caps are positioned in the first pocket of the first and second jambs, respectively.

According to another example further to Example 8 (“Example 12”), the catch element is positioned on the housing such that the housing engages with the first rail of the sash.

According to another example further to Example 8 (“Example 13”), the screen assembly is engaged with the first pocket of the frame.

According to another example further to Example 8 (“Example 14”), the first and second jambs of the frame further include a second pocket, wherein the screen assembly is engaged with the second pocket of the frame.

According to another example further to Example 14 (“Example 15”), a portion of the screen extends out from the housing into the second pocket of the frame.

According to another example further to Example 15 (“Example 16”), the portion of the screen extending out from the housing includes longitudinal slits.

According to another example further to Example 14 (“Example 17”), the fenestration unit further includes an insert couplable to the first portion of the frame to form a recess, wherein the first housing member of the screen assembly is configured to be positioned in the recess formed by the insert and the first portion of the frame.

According to another example further to Example 8 (“Example 18”), the fenestration unit further including a first cord and a second cord extending from the frame and coupled to the housing of the screen assembly, wherein the first and second cords both extend along a shared length of a longitudinal length of the housing.

According to another example further to Example 8 (“Example 19”), the fenestration unit further including: a second sash, wherein the frame includes a second pocket with which the second sash is engaged and in which the second sash is operable to translate relative to the frame; a second screen assembly operable to extend between the second portion of the frame and the second sash.

According to one example (“Example 8”), a method of providing a screen assembly on a fenestration unit is provided, wherein the fenestration unit includes a frame having a first portion, a second portion opposite the first portion, a first jamb extending between the first portion and the second portion, and a second jamb opposite the first jamb and extending between the first portion and the second portion, wherein the first jamb and the second jamb each include a first pocket, and a sash including a first rail, a second rail opposite the first rail, a first stile extending between the first and second rails, and a second stile opposite the first stile and extending between the first and second rails, wherein the first and second stiles are positioned in the first pocket of the first and second jamb such that the sash is configured to translate within the first pocket relative to the frame, the method including: engaging end caps of a screen assembly with the first pocket of the frame; coupling a first housing member of the screen assembly to the first portion of the frame, such that when the sash is translated between an open and a closed position, the second housing member remains positioned with the first portion of the frame; and releasably coupling a second housing member of the screen assembly to the sash of the fenestration unit such that a catch element of the first housing member engages with a wash lock of the sash.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a front view of an interior-facing side of a double hung fenestration unit or assembly, according to some embodiments of the disclosure.

FIG. 2 is a front view of an interior-facing side of a single hung fenestration unit, according to some embodiments of the disclosure.

FIG. 3 is a perspective view of a screen assembly, according to some embodiments of the disclosure.

FIG. 4 is a side view of the screen assembly of FIG. 3, according to some embodiments of the disclosure.

FIGS. 5A-5C are side views of a screen assembly having a coupling member and a sash that is being engaged by the coupling member, according to some embodiments of the disclosure.

FIG. 6 is a side view of a screen assembly having a coupling member with an engagement portion and a sash that is engaged by the coupling member, according to some embodiments of the disclosure.

FIG. 7 is a perspective view of a screen assembly and a sash including a wash lock for engaging the screen assembly, according to some embodiments of the disclosure.

FIGS. 8A-8C are front, side, and perspective views of an end cap, according to some embodiments of the disclosure.

FIG. 9 is a perspective view of a portion of a fenestration unit showing an example of how the screen assembly engages with a pocket of the frame via the endcaps of the screen assembly, according to some embodiments of the disclosure.

FIG. 10 is a perspective view of a portion of the fenestration unit showing an example of how the screen assembly is engaged with a sash via a coupling member and engaged with a pocket of the frame via the endcaps of the screen assembly, wherein the screen is at least partially deployed, according to some embodiments of the disclosure.

FIG. 11 is a side view of a portion of a frame including an insert used to form a screen assembly recess, according to some embodiments of the disclosure.

FIG. 12 is a sectional view of a portion of the frame including an insert used to form a screen assembly recess in which a portion of the screen assembly is positioned when the screen is at least partially deployed, according to some embodiments of the disclosure.

FIG. 13 is a side, sectional view of a screen assembly and sash with various guards for preventing entry of debris, moisture, or insects through the fenestration unit, according to some embodiments of the disclosure.

FIG. 14 is a perspective view of a portion of a fenestration unit showing a sash of the fenestration unit pivoted away from the frame of the fenestration unit, according to some embodiments of the disclosure.

FIG. 15 is a perspective view of a portion of a fenestration unit, with a jamb of the fenestration hidden from view to show a sash pivoted away from the frame such that the screen assembly is disengaged from the sash, according to some embodiments of the disclosure.

FIG. 16 is a side, sectional view of a screen assembly engaged with a sash where the screen assembly and the sash are positioned and operate within the same plane as defined by the direction of movement of the components, according to some embodiments of the disclosure.

FIG. 17 is a side, sectional view of a screen assembly with a screen partially deployed and the screen assembly engaged with a sash where the screen assembly and the sash are positioned and operate within the same plane as defined by the pocket which restricts the movement of the sash and screen assembly, according to some embodiments of the disclosure.

FIG. 18 is a perspective view of a portion of a fenestration unit, with a jamb of the fenestration unit hidden from view to show a partially deployed screen assembly coupled to a sash within the same plane as defined by the pocket, according to some embodiments of the disclosure.

FIG. 19 is a top view of a screen extending from the housing into the pocket, according to some embodiments.

FIG. 20 is a side view of a screen assembly including cords used to support deployment of the screen assembly, according to some embodiments.

FIG. 21 is a side, sectional view of a screen assembly and a sash including one embodiment of an end cap and various guards and watersheds, according to some embodiments.

FIG. 22 is a side, sectional view of a screen assembly and a sash including another embodiment of an end cap and various guards and watersheds, according to some embodiments.

FIG. 23 is a perspective view of a cord routing system, according to some embodiments.

FIGS. 24A-24H are close up views of transitions in direction of a cord in a cord routing system, according to some embodiments.

FIG. 25 is a front view of a screen assembly and routing system, the routing system using a primary and secondary cord for supporting the screen assembly, according to some embodiments.

FIG. 26 is a top view of an end cap positioned in a pocket, according to some embodiments.

FIG. 27 is a side view of a coupling member and control bar, according to some embodiments.

FIGS. 28A and 28B are side views of a coupling member where a screen assembly and sash are engaged when the sash in an open position and a closed position, respectively, according to some embodiments.

FIG. 29A is a perspective view of a screen assembly, according to some embodiments.

FIG. 29B is a side view of a screen assembly being rotated to detach from the sash, according to some embodiments.

FIG. 30 is a side view of a coupling member, a control bar, and an end cap positioned out of plane with a sash, according to some embodiments.

FIG. 31 is a front view of a screen assembly, according to some embodiments.

FIG. 32 is a sectional view of a screen assembly and sash implementing a clip system, according to some embodiments.

FIG. 33 is a sectional view of the clip system of FIG. 32 illustrating decoupling of the screen assembly from the sash, according to some embodiments.

FIG. 34 is a sectional view of the clip system of FIG. 32 illustrating rotating of the sash as the screen assembly is decoupled from the sash, according to some embodiments.

FIG. 35 is an end cap with cord routing, according to some embodiments.

While the inventive concepts addressed herein are amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Some inventive concepts provided by this disclosure relate to integrated screen features, enhanced bug sealing between sashes, and others. These inventive concepts are examples only, and further inventive concepts, as well as their advantages and associated functions will be appreciated from this disclosure.

In some examples, fenestration units are provided that allow a user to view through the glazing panels of a fenestration unit without the obstruction of a screen or the like while having the ability to open the fenestration unit and have a screen unit to prevent debris and pests from entering through the fenestration unit. Furthermore, the disclosed device provides the advantage of a retractable screen that does not have a mechanism that pulls the fenestration unit to a closed position if the fenestration unit is slidable with minimum force. Furthermore, the required force to slide the fenestration unit may be maintained at a minimal level because the screen assembly does not exert a force for rehousing or recoiling the screen. Another advantage includes a tighter fit between the screen and the frame during use, thus minimizing the space through which debris and pests may enter through the fenestration unit. Another advantage includes a pleated screen that is released in a relatively flatter configuration so as to minimize obstruction of the view due to pleating. Another advantage includes a screen assembly that may be installed on a new fenestration unit or that may be retrofitted onto an existing fenestration unit.

This disclosure is not meant to be read in a restrictive manner. For example, the terminology used in the application should be read broadly in the context of the meaning those in the field would attribute such terminology. Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

With respect terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error or minor adjustments made to optimize performance, for example. In the event it is determined that individuals having ordinary skill in the relevant arts would not readily ascertain values for such reasonably small differences, the terms “about” and “approximately” can be understood to mean plus or minus 10% of the stated value.

Certain terminology is used herein for convenience only. For example, words such as “top”, “bottom”, “upper,” “lower,” “left,” “right,” “horizontal,” “vertical,” “upward,” and “downward” merely describe the configuration shown in the figures or the orientation of a part in the installed position. Indeed, the referenced components may be oriented in any direction. Similarly, throughout this disclosure, where a process or method is shown or described, the method may be performed in any order or simultaneously, unless it is clear from the context that the method depends on certain actions being performed first.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

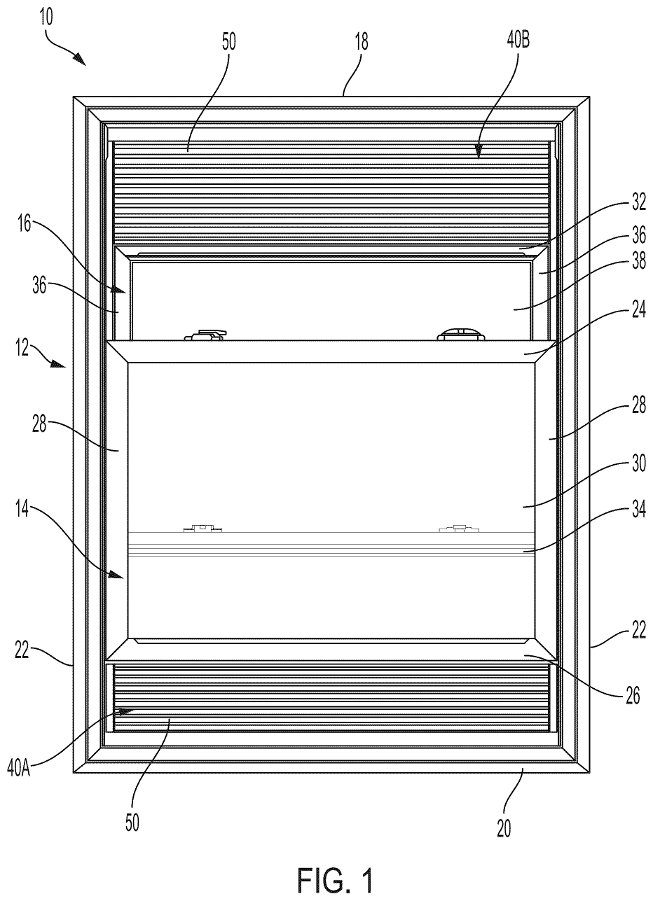

FIG. 1 is a front view of an interior-facing side of a fenestration unit 10, also described as a fenestration assembly 10, according to some embodiments of this disclosure. By “interior-facing side” it is meant the side of the fenestration unit that typically faces toward an interior of a building structure into which the fenestration unit is installed. As shown, the fenestration unit 10 is a double-hung window that includes a frame 12, a first sash 14, and a second sash 16. The frame 12 can include a first portion, or head 18, a second portion, or sill 20, and jambs 22. Together, the head 18, the sill 20, and the jambs 22 surround and support the first sash 14 and the second sash 16. The first sash 14 can include an upper rail 24, a lower rail 26, stiles 28, and window pane 30. Together, the upper rail 24, the lower rail 26, and the stiles 28 surround and support the window pane 30. The second sash 16 can include an upper rail 32, a lower rail 34, stiles 36, and window pane 38. Together, the upper rail 32, the lower rail 34, and the stiles 36 surround and support the window pane 38.

As shown in FIG. 1, fenestration unit 10 includes one or more screen assemblies 40, including, for example, a first screen assembly 40A and a second screen assembly 40B. Each of the screen assemblies 40A, 40B include a screen 50 that is operable extend across openings formed when sashes 14, 16 are opened on the fenestration unit 10. The first screen assembly 40A can extend between the sill 20 and the lower rail 34 of the second sash 16. The second screen assembly 40B can extend between the head 18 and the upper rail 24 of the first sash 14. In FIG. 1, the first sash 14 and the second sash 16 are both shown in open configurations. That is, the first sash 14 is not in contact with the sill 20 and the second sash 16 is not in contact with the head 18. It will be understood that a fenestration unit 10 may include any number of screen assemblies 40 as appropriate in specific embodiments (e.g., a single hung fenestration unit may include a single screen assembly 40).

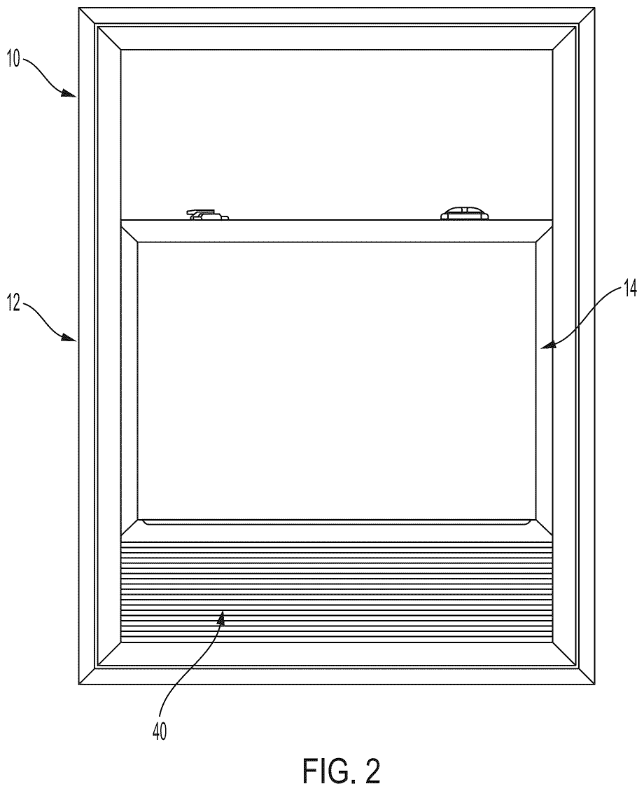

FIG. 2 shows an embodiment of a fenestration unit 10 similar to that of FIG. 1, where FIG. 1 depicts a double hung fenestration unit and FIG. 2 depicts a single hung fenestration unit. It is within the scope of the disclosure that various types of fenestration units may be implemented in conjunction with screen assemblies (e.g., single hung, double hung, and sliding fenestration units). As a primary difference, the fenestration unit of FIG. 2 is not shown to include both the first screen assembly 40A and second screen assembly 40B of FIG. 1, but instead is shown with a single screen assembly 40 as only a single, venting sash is included in the single hung configuration of FIG. 2.

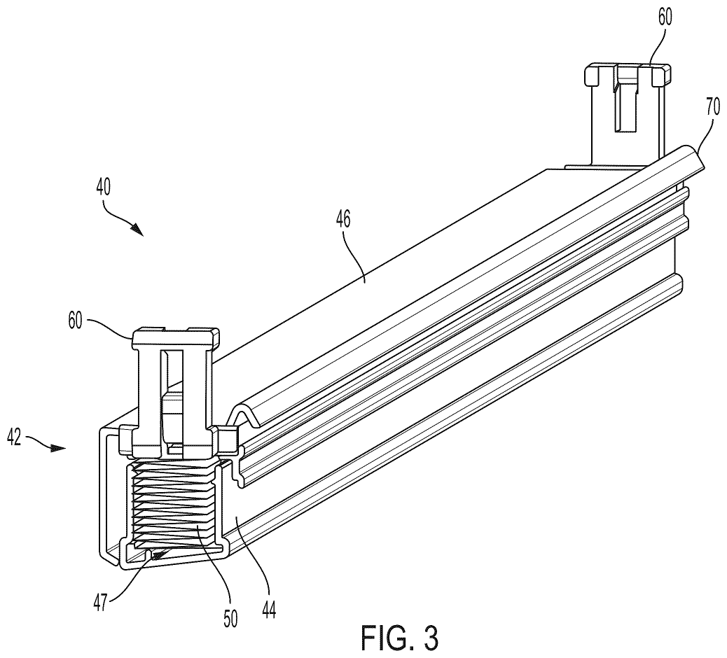

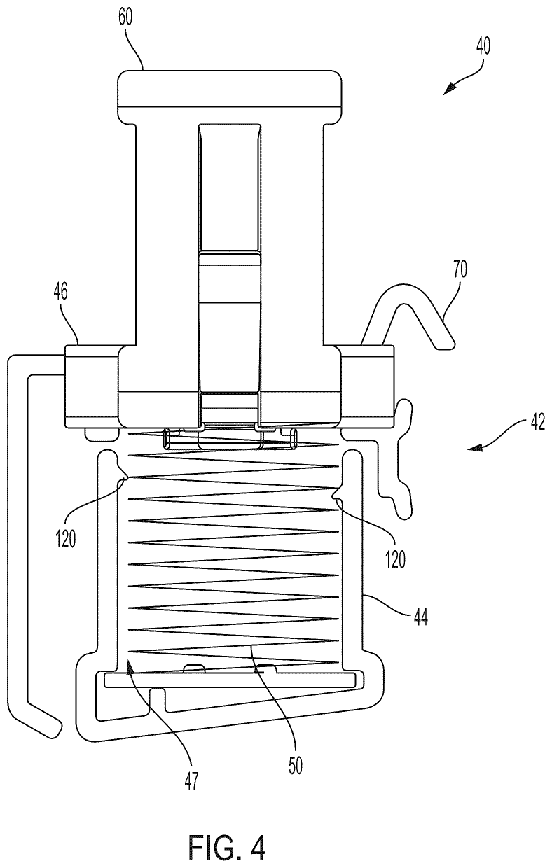

FIGS. 3 and 4 show a screen assembly 40 according to some embodiments. As shown, the screen assembly 40 includes a housing 42 having a first housing member 44 and a second housing member 46. The first and/or second housing members 44, 46 may form a screen retention space 47 operable to retain a screen 50. For example, the first housing member 44 includes a screen retention space 47 in which the screen is retained when the fenestration unit 10 is in a closed configuration. The second housing member 46 acts as a cover for the screen retention space 47 when the fenestration unit 10 is in a closed configuration (e.g., as seen in FIG. 4). As shown, in various examples, the screen 50 is positioned substantially inside of the housing 42 when the housing is in a closed position, or in alternative terms the screen 50 is enclosed within the housing 42 when the housing is in the closed position. The screen 50 may be disposed in the housing 42 such that screen 50 is pleated or folded. The screen 50 (e.g., pleated screen) includes a first end 52 coupled to the first housing member 44 and a second end 54 coupled to the second housing member 46. The screen 50 may be coupled to the housing 42 via various coupling mechanisms (e.g., plastic welding, sewing, mechanical fasteners, etc.). In some embodiments, the screen is coupled to an intermediate member 48 which may then be coupled to the housing 42 (e.g., as seen in FIG. 4).

In some embodiments, the screen assembly 40 includes end caps 60 that facilitate positioning of the screen assembly 40 as part of the fenestration unit 10. The end caps 60 may serve various functions which will be described hereafter. The end caps 60, according to some embodiments, are positioned on the housing 42 of the screen assembly (e.g., at the longitudinal ends of the either the first or second housing members 44, 46).

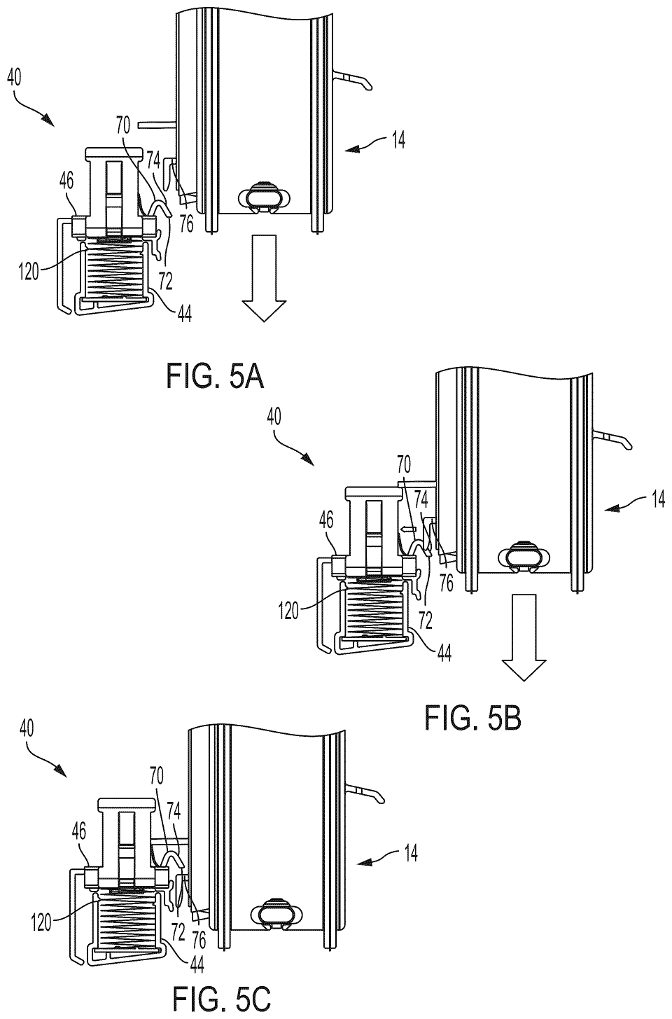

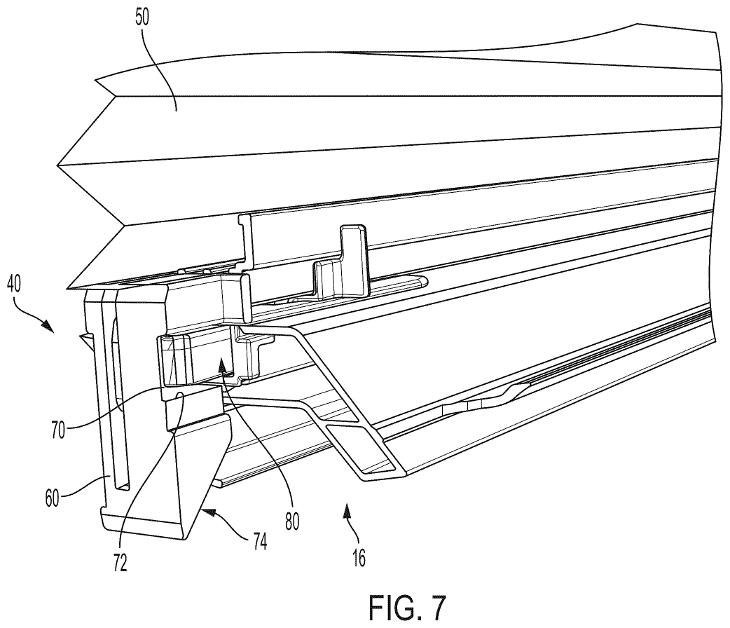

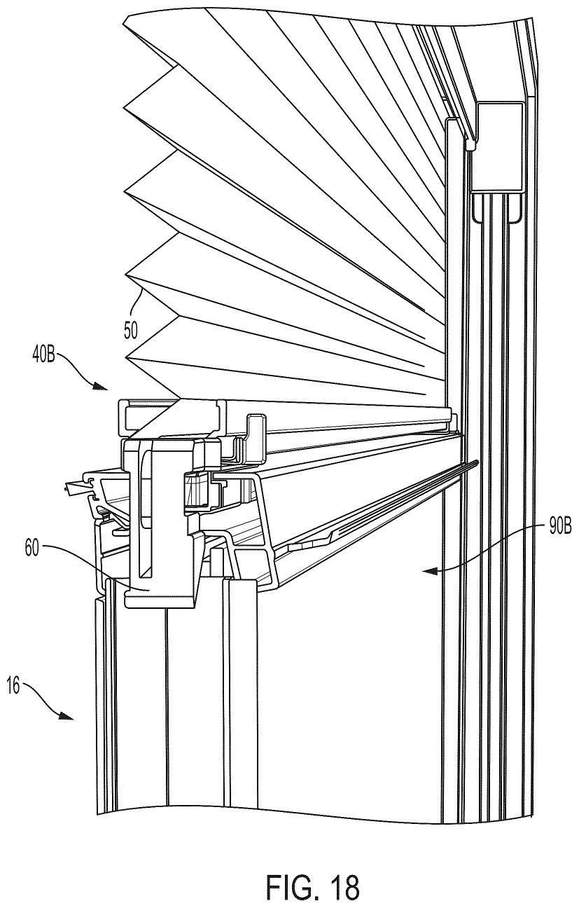

Because the screen 50 is configured to extend across openings when the sashes 14, 16 of the fenestration unit 10 are opened, at least a portion of the screen assembly 40 may be coupled to one of the sashes 14, 16 and at least a portion of the screen assembly 40 may be coupled to the frame 12 of the fenestration unit 10 (e.g., as shown the first housing member 44 is coupled to the sash 14 and the second housing member 46 is coupled to the frame 12). In some embodiments, the screen assembly 40 is coupled to the sash 14, 16 via the end caps 60 (see, e.g., FIGS. 7 and 18) and in other embodiments the screen assembly 40 includes a coupling member 70 for engaging the sashes 14, 16 during opening and closing of one of the sashes 14, 16 (see, e.g., FIGS. 5 and 10). In some embodiments, the coupling member 70 optionally engages with one of the sashes 14, 16 such that the coupling member 70 and the screen assembly 40 generally can be disengaged from the sash 14, 16. In some embodiments, the coupling member 70 may be integrated onto the end caps 60 or the coupling member 70 may extend from the first or second housing member 44, 46. It will be understood that the coupling member 70 can help facilitate engagement and coupling of the screen assembly 40 with one of the sashes 14, 16.

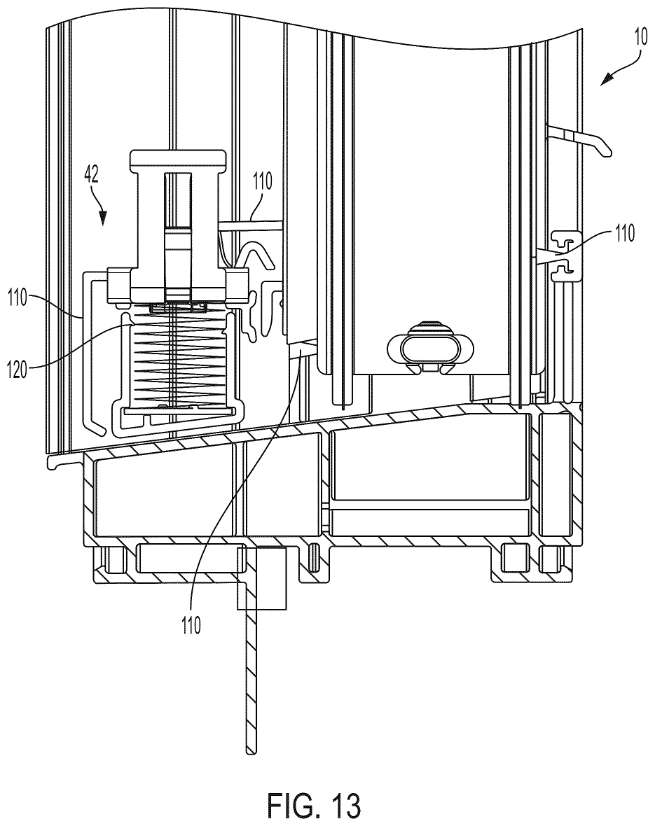

Referring now to FIGS. 5A-5C, an embodiment of a screen assembly 40 is provided in which a screen assembly 40 includes a first housing member 44 and a second housing member 46 having a coupling member 70 extending therefrom. The coupling member 70, in this embodiment, includes an engaging surface 72 and a deflecting surface 74. The engaging surface 72 is operable to engage one of the sashes 14, 16 such that when the corresponding sash 14 or 16 is moved to an open position, the second housing member 46 is also translated to an at least partially deployed position. In some embodiments, the corresponding sash 14 or 16 includes an engaging surface receiver 76 for establishing and maintaining contact between the screen assembly 40 and one of the sashes 14 or 16. The screen assembly 40 is optionally able to be disengaged from one of the sashes 14, 16. For example, when the screen assembly 40 (e.g., first screen assembly 40A or second screen assembly 40B) is optionally disengaged from one of the sashes 14, 16 (which will be discussed in relation to FIGS. 13 and 14), the screen assembly 40 and the sash 14 or 16 may be reengaged by arranging the engaging surface 72 of the coupling member 70 against the engaging surface receiver 76 of the sash 14 or 16. This may be done manually (e.g., by pulling directly on the screen assembly 40), or the corresponding sash 14 or 16 may be translated toward the screen assembly 40 until the engaging surface receiver 76 contacts the deflecting surface 74. Once the engaging surface receiver 76 and the deflecting surface 74 are in contact, the engaging surface receiver 76 may be pushed against the deflecting surface 74 such that the coupling member 70 deflects away from a neutral position to allow the engaging surface receiver 76 to travel past the coupling member 70. Once the engaging surface receiver 76 has cleared the coupling member 70, the coupling member 70 returns to a neutral position, which allows for the engaging surface 72 of the coupling member 70 to engage with the engaging surface receiver 76 of one of the sashes 14, 16. It will be noted that the coupling member 70 may include multiple members spaced along the longitudinal length of the screen assembly 40, or it may be a single member positioned along at least a portion of the longitudinal length of the screen assembly 40.

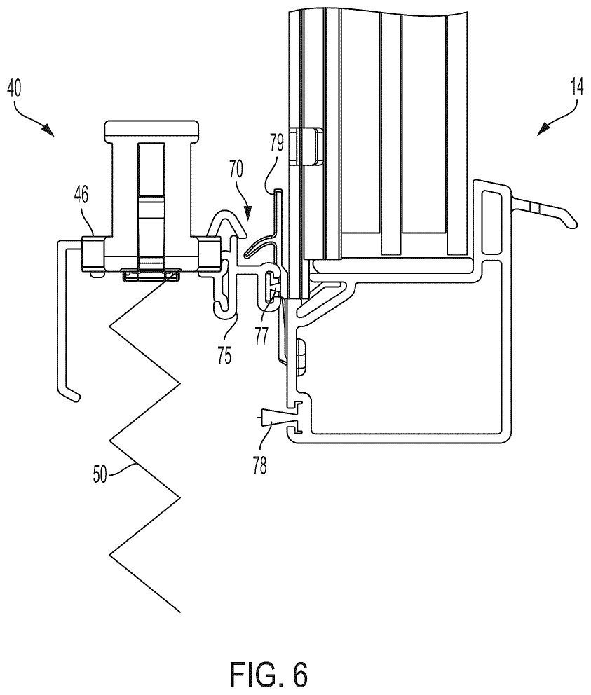

Referring now to FIG. 6, in an alternative embodiment of a coupling member 70 extending from the screen assembly 40 is provided in which the coupling member 70 is operable to interface with a respective sash 14 or 16. The coupling member 70, in the embodiment shown in FIG. 6, includes an engagement portion 75, the engagement portion operable to engage with the respective sash 14 or 16. For example, the engagement portion 75 may include a weather stripping 77 which is positioned against the first sash 14. The weather stripping 77 is operable to prevent debris, moisture, and/or pests from entering the fenestration unit 10 between the screen assembly 40 and the first sash 14. Furthermore, the weather stripping 77 is positioned against the first sash 14 such that sufficient friction is present between the weather stripping 77 and the first sash 14, such that the second housing member 46 of the screen assembly 40 substantially follows the movement of the first sash 14 when the first sash 14 is transitioned to various positions within the fenestration unit 10. In some embodiments, the sash 14 or 16, may include a stopping member 79 which is operable to interfere with the second housing member 46 of the screen assembly 40, when the second housing member 46 travels towards a center portion of the sash 14 or 16. Thus, the stopping member 79 limits movement of the second housing member 46 relative to the associated sash 14 or 16 such that the second housing member 46 and the screen 50 do not obscure the view through the glazing panels of the sash 14 or 16.

In some embodiments, the sash 14 or 16 may include a second weather strip 78 positioned distal from the stopping member 79, such that the second weather strip 78 is positioned nearer the edge of the sash 14 or 16 relative to the stopping member 79. Thus, the engagement portion 75 and specifically the first weather stripping 77 may be positioned laterally between the stopping member 79 and the second weather strip 78 relative to the sash 14 or 16. In some embodiments, the two weather strips 77, 78 interfere with one another such that the engagement portion 75 engages with and does not travel past the second weather stripping 78. However, upon application of sufficient force, the engagement portion 75 is able to travel past the second weather stripping 78, thus disengaging the second housing member 46 from the sash 14 or 16. This allows for the screen assembly 40 to be disengaged from the sash 14 or 16 to allow for an unrestricted or unobstructed opening of the fenestration unit 10 if desired. In order to achieve sufficient force to disengage the sash 14 or 16 and the screen assembly 40, stops (not shown) may be positioned on the fenestration unit 10 that restrict travel of the second housing member 46 of the screen assembly 40 beyond a predetermined position, such that if the sash 14 or 16 is forced to travel beyond that predetermined position, the second housing member 46 and the sash 14 or 16 disengage. To reengage the screen assembly 40 and the sash 14 or 16, the sash 14 or 16 may be transitioned to a closed position and sufficient force is applied to the sash such that the engagement portion 75 is able to travel past the second weather stripping 78.

Referring now to FIG. 7, one embodiment of the screen assembly 40 is shown in connection with the sash 16 (where the vertical members are hidden) and includes that the coupling member 70 is defined on the end caps 60. The end caps 60 may similarly include an engaging surface 72 and a deflecting surface 74. The engaging surface 72 and deflecting surface 74 of the coupling member 70 of the end caps 60 are operable to engage with a wash lock 80 of one of the sashes 14, 16. A wash lock 80 may be generally be provided in some embodiments of the present disclosure for allowing a sash 14 or 16 or a portion of a sash 14 or 16 to be removed from the fenestration unit 10. The wash lock 80 may allow the sash 14 or 16 to disengage at least partially such that the sash can be rotated away for cleaning, replacement, repair, or otherwise. The wash lock 80, as seen in FIG. 7, may extend from the longitudinal ends of the sashes 14, 16. When the engaging surface 72 is engaged with the wash lock 80, the corresponding sash 14 or 16 may be moved to an open position which results in the second housing member 46 also being translated to an at least partially deployed position.

In various examples, the screen assembly 40 may be disengaged from the sash 14 or 16 by articulating the wash lock 80 such that the coupling member 70 is able to travel past the wash lock 80. To reengage the coupling member 70 with the wash lock 80, the wash lock may be manually articulated such that the coupling member 70 can be positioned to contact the wash lock 80 is returned to an extended position. Furthermore, the coupling member 70 and the wash lock 80 may be reengaged by translating the corresponding sash 14 or 16 toward the screen assembly 40 until wash lock 80 contacts the deflecting surface 74. Once the wash lock 80 and the deflecting surface 74 are in contact, the wash lock 80 may be pushed against the deflecting surface 74 such that the wash lock 80 is articulated inward to allow the wash lock 80 to travel past the deflecting surface 74 of the end caps 60. Once the wash lock 80 has cleared the deflecting surface, the wash lock 80 returns to a neutral position, which allows for the engaging surface 72 of the coupling member 70 to engage with the wash lock 80 one of the sashes 14, 16. It will be understood that the coupling member 70 discussed with reference to FIG. 7 may also be included directly on one of the first or second housing members 44, 46 such that the wash lock 80 engages with the coupling member 70 on the first or second housing member.

It will be understood that the various examples of the coupling member 70 may be implemented in various embodiments and configurations, for example, with double-hung fenestration units, single-hung fenestration units, and sliding fenestration units, regardless of orientation, including horizontal and vertical.

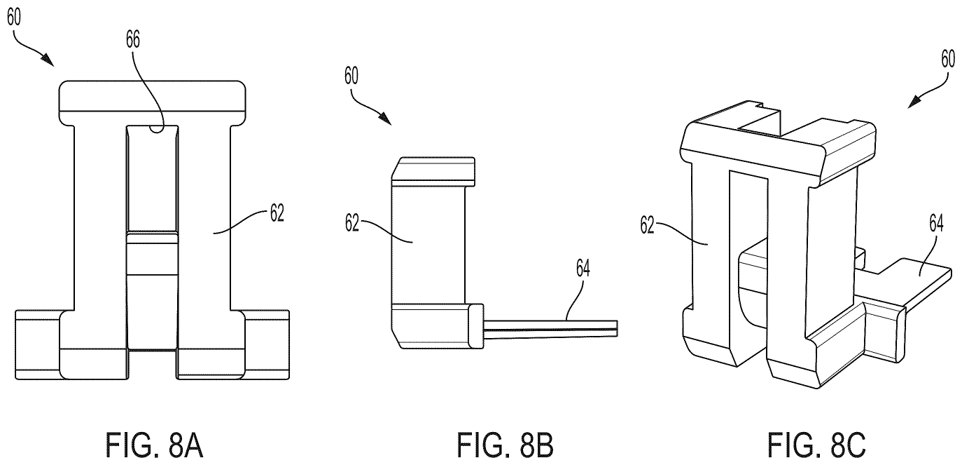

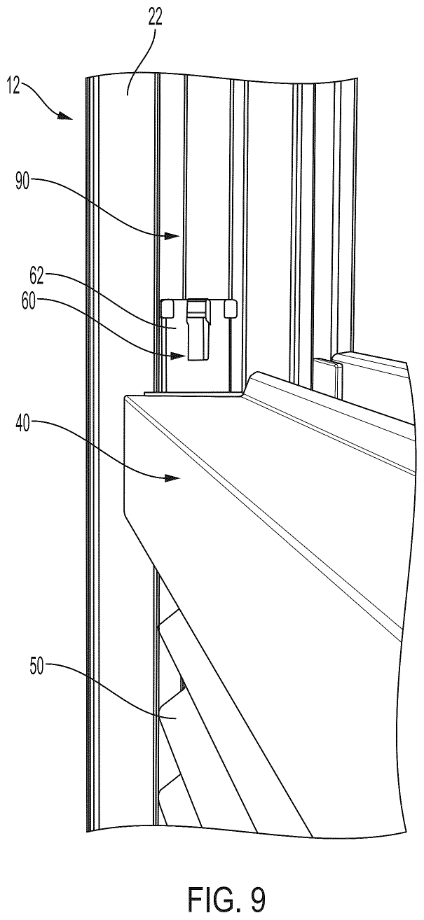

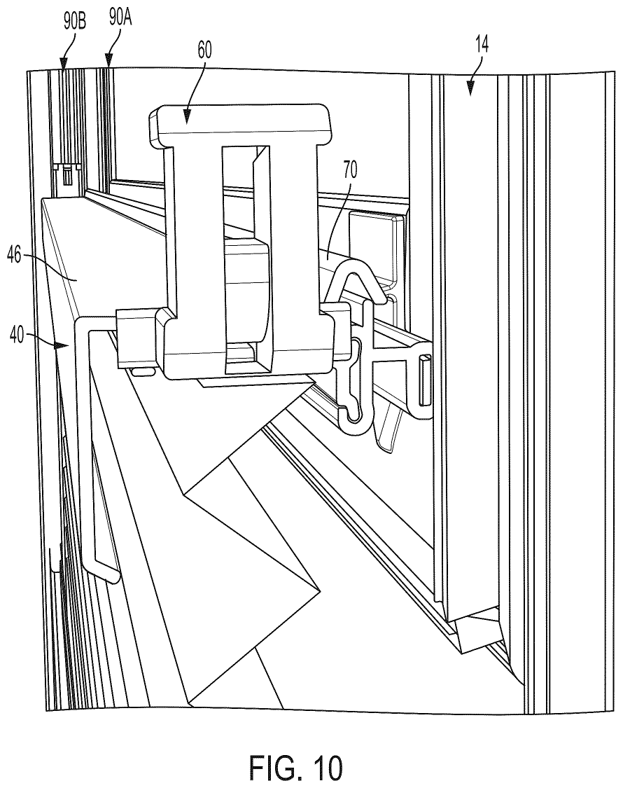

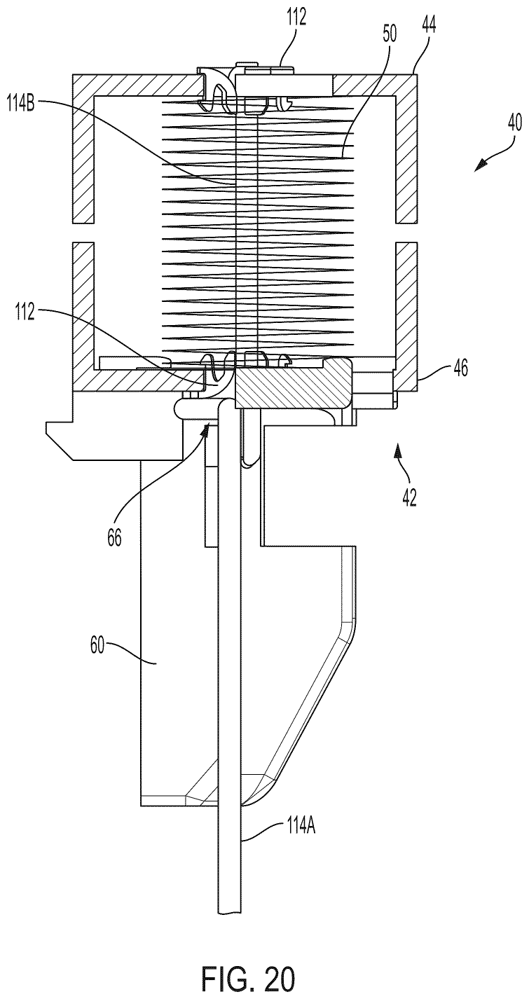

Turning now to a discussion of an embodiment of the end caps 60, FIGS. 8A-9C provide an exemplary embodiment of an end cap 60 although other embodiments may be implemented as seen in FIGS. 7 and 18 or as seen in FIGS. 20-22. Each end cap 60 includes a body 62 and a coupling portion 64 extending from the body 62. The coupling portion 64 is operably to couple to either the first or second housing member 44 or 46. The end caps 60 include a gliding surface 66 which allows for cords (which will be discussed hereafter) to transition directions at a predefined angle. For example, the gliding surface 66 may permit a cord to transition from a vertical orientation to a horizontal orientation or from a horizontal orientation to a vertical orientation at the end caps 60.

When the end caps 60 are installed on the screen assembly 40, the screen assembly 40 may be installed with the frame 12 of the fenestration unit 10. Referring to FIG. 9, the end caps 60 may be positioned in the pockets 90 of the frame 12. In general, the pockets 90 may be formed in the frame 12 of the fenestration unit 10 in order to receive the sashes 14,16, and specifically the stiles of the sashes 14, 16, such that the sashes 14,16 may be operable to translate within the pockets 90 when opened and closed. More specifically, the pockets 90 may define a recess in the jambs 22 of the frame 12. It will be understood that any number of pockets 90 may be formed in the frame 12. The body 62 of each of the end caps 60 is operable to be positioned in the pockets 90 such that the end caps 60 are rotationally constrained and are operable to travel along the length of the corresponding pocket 90. In some embodiments, the body 62 of each of the end caps 60 is elongated in order to provide enhanced rotational stability. Thus, when a screen assembly 40 is engages with one of the sashes 14, 16, and the corresponding sash 14 or 16 is opened, the end caps 60 are operable to travel within the pockets 90, thus allowing the screen 50 to be at least partially deployed.

Referring now to FIG. 10, in those embodiments in which the coupling member 70 extends from the first or second housing member 44 or 46, the end caps 60 of the screen assembly 40 may be positioned in first pocket 90A and the corresponding sash 14 or 16 with which the screen assembly 40 is engaged may be positioned partially within the second pocket 90B. Thus, in some embodiments, the screen assembly 40 may be offset from the corresponding sash 14 or 16, meaning the screen assembly is set in a first plane defined by the first pocket 90A and the corresponding sash 14 or 16 is set in a second plane defined by the second pocket 90B. However, the disclosure is not limited to including a screen assembly 40 offset from the corresponding sash 14 or 16. In some embodiments, the screen assembly 40 is positioned in the same plane as the corresponding sash 14 or 16, where the plane is defined by the pocket 90, as seen in FIGS. 7 and 16-18.

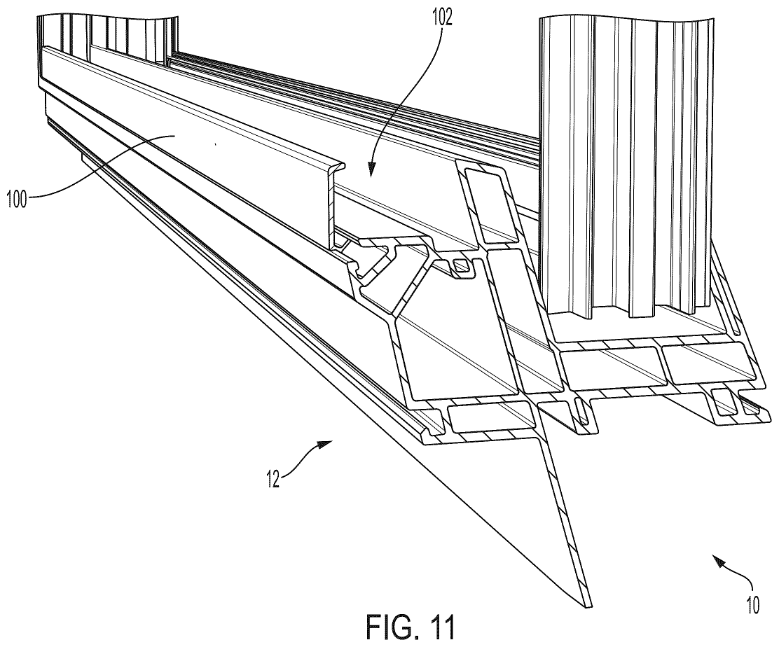

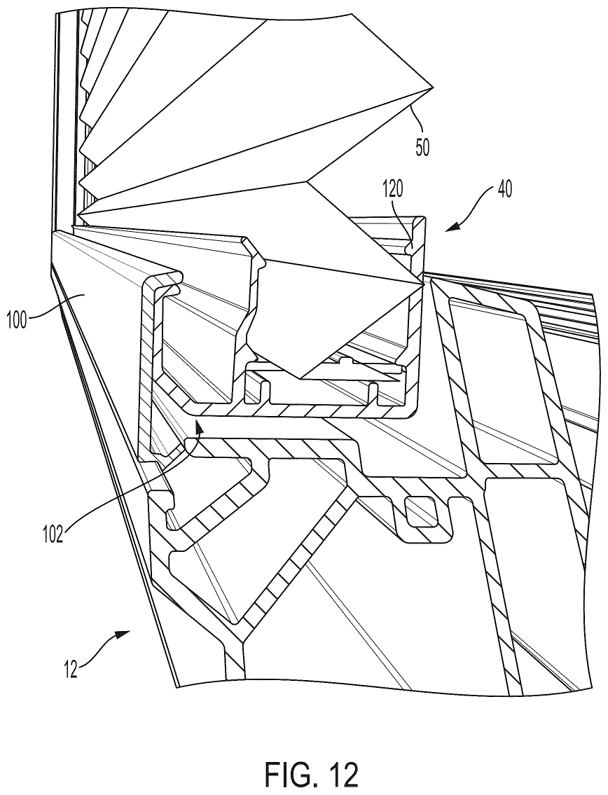

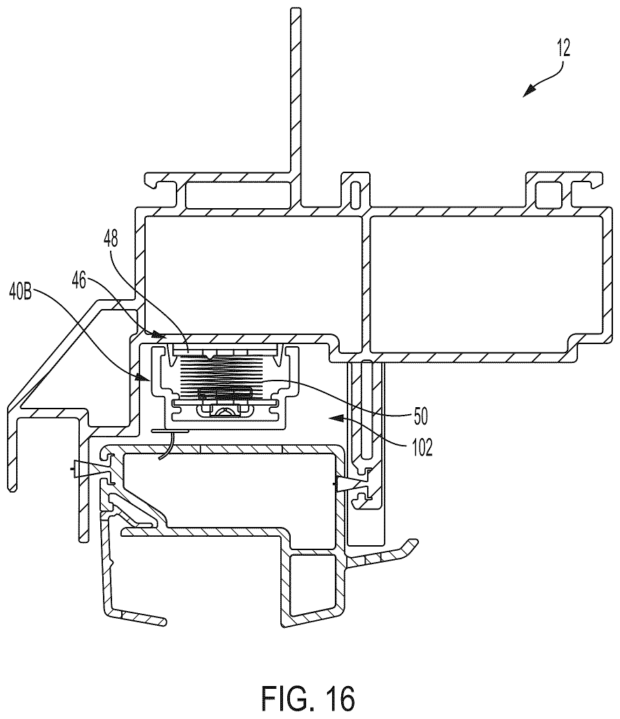

As seen in FIGS. 11 and 12, the fenestration unit 10 may include an insert 100 that is operable to be coupled to the frame 12. The insert 100 may be used to form a screen assembly recess 102 in which the screen assembly 40 may be positioned and stored out of the line of sight and at least partially shielded from the elements including debris and moisture. In some embodiments, the insert may be formed to integrate with existing structure of the frame such as channels, receivers, and complementary structure for engagement. However, the insert 100 may be coupled to the frame 12 by any appropriate method, including adhesives and welds among others. It will also be understood that the screen assembly recess 102 may be integrally formed on the frame 12, according to some embodiments, and as can be seen in FIG. 16. Similarly, the insert 100 may be coupled or extend from the frame 12 to form a pocket on those fenestration units 10 that do not have a pocket integrally formed in the fenestration unit 10.

As can also be seen in several of the figures, including FIG. 13, the fenestration unit 10 may implement various seals or guards 110 to prevent moisture, debris, or insects from traversing around the screen assembly such as above, below, or around the sides of the housing 42. These seals or guards 110 may include brush-type filters, silicon or polymeric flaps or membranes, or metal or polymeric shields.

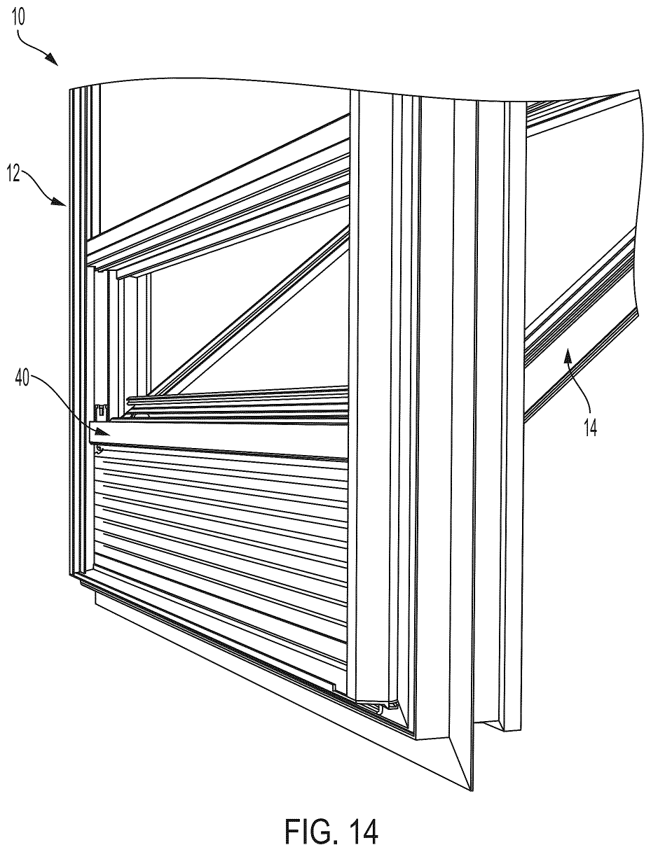

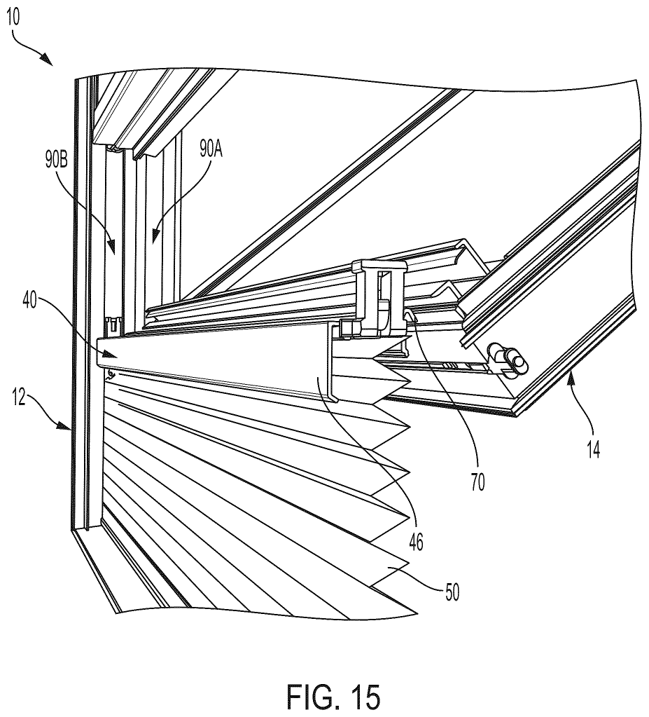

Referring now to FIGS. 14 and 15, in some embodiments, the screen assembly 40 may be disengaged from the corresponding sash 14 or 16 by engaging a pivot feature of the sash 14 or 16. For example, when a screen assembly 40 is engaged with the first sash 14 via a coupling member 70 extending from the second housing member 46 of the screen assembly 40, the first sash 14 can be partially released from the frame 12 in order to pivot away from the frame 12. This may be an existing feature of the fenestration unit 10 in order to remove or partially remove the sashes 14, 16 for cleaning, maintenance, replacement, or otherwise. As the first sash 14 pivots away from the frame 12, the coupling member 70 transitions to no longer be in contact with the first sash 14. When the coupling member 70 of the screen assembly 40 and the first sash 14 are not in contact, the second housing member 46 of the screen assembly 40 may be translated within the second pocket 90B independent of the movement of the first sash 14. Once the first sash 14 is returned back into the frame 12, the first sash 14 and the screen assembly 40 may be reengaged as previously discussed.

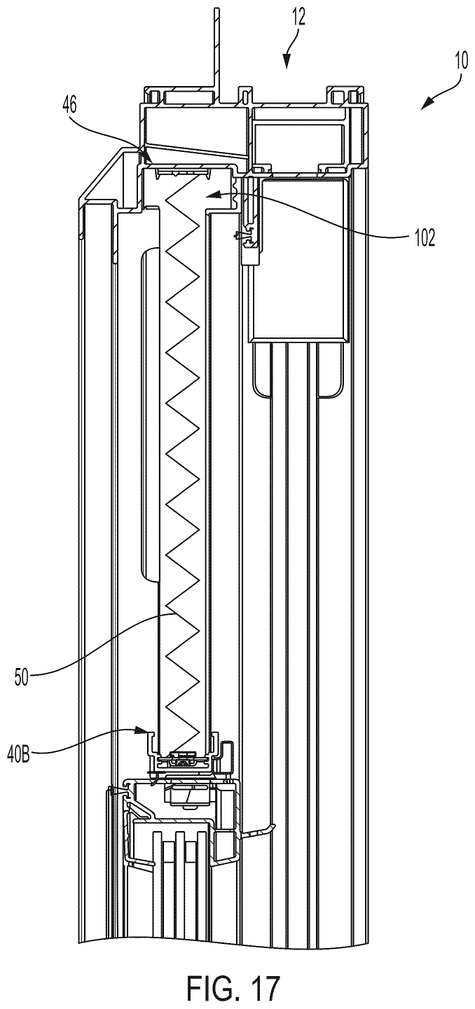

Referring now to FIGS. 16-17, a second screen assembly 40B may be provided. The second screen assembly 40B may include any of the features described previously, including the position and interaction with the described fenestration unit 10. In some embodiments, the second screen assembly 40B is coupled to the second sash 16. As can be seen in FIG. 16, the frame 12 may include a screen assembly recess 102. It will be noted that the second housing member 46 of the second screen assembly 40B may be integrated into the frame 12 at the screen assembly recess 102 such that an intermediate member 48 coupled to the screen 50 may be coupled directly to the frame 12 via the integrated second housing member 46. Stated otherwise, the screen 50 or the intermediate member 48 may be coupled directly to the frame 12 depending on the particular configuration employed.

FIGS. 17 and 18 show an at least partially deployed configuration of a second screen assembly 40B. The screen 50 and end caps 60 may be at least partially contained in the second pocket 90B. In this embodiment, the screen assembly 40 and the sash 16 both travel in the same plane as constrained by the pocket 90.

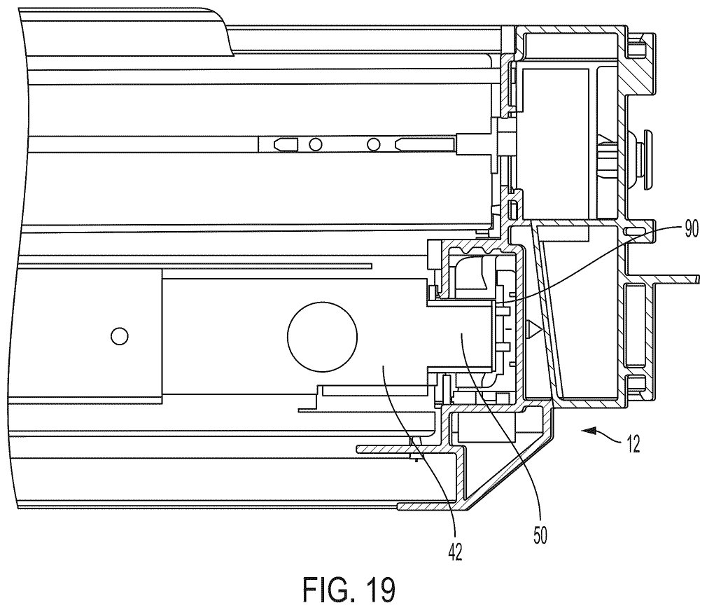

Referring now to FIG. 19, in some embodiments the screen 50 may extend out from longitudinal ends of the housing 42 of the screen assembly 40. When the screen extends out of the housing 42, the screen may be partially positioned within the pocket 90 of the frame 12. The longitudinal ends of the screen extending out from the housing may include longitudinal slits. The longitudinal slits allow for the screen to have flexible edges and those reduce interference of the screen 50 with the movement of the sash 14 or 16 within the pocket 90.

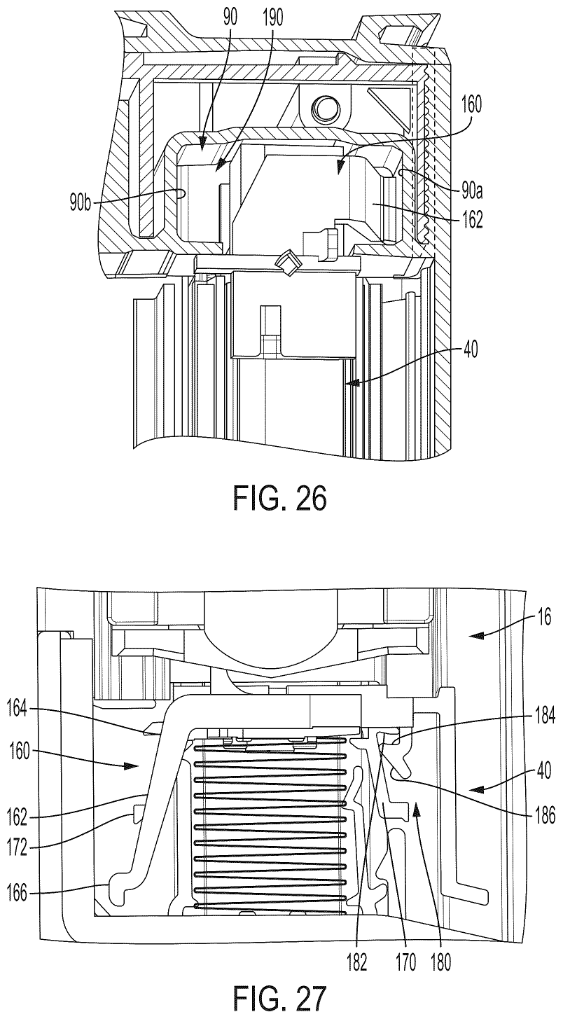

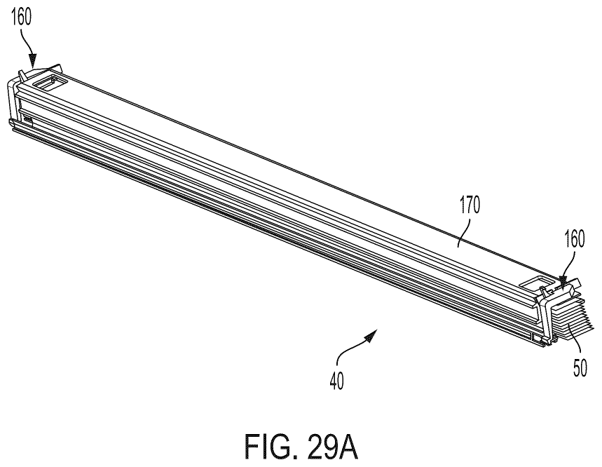

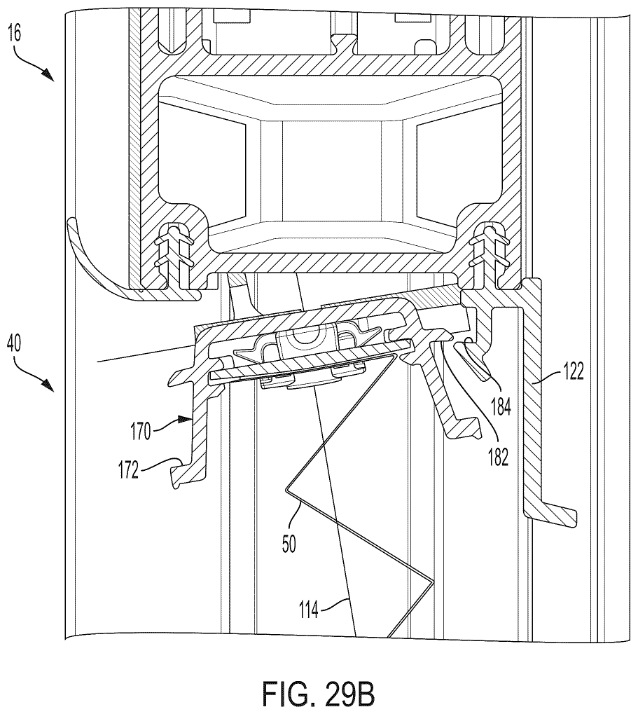

Referring to FIGS. 26-30, another embodiment of a screen assembly 40 is provided. Referring more specifically to FIG. 29A, the screen assembly 40 is illustrated including the screen, endcaps 160 positioned at longitudinal ends of the screen assembly, and a control bar 170. In this embodiment, and further referring to FIGS. 26-30, the end caps 160 are operable to rotate or rock. By rotating or rocking the screen assembly 40 and the end caps 160, the screen assembly 40 is operable to disengage from the respective sash, thus allowing the sash 16 to operate independent of the screen assembly 40. In this embodiment, the screen assembly 40 can be released from the sash 16 by rotating a portion of the screen assembly 40 rather than and/or in addition to rotating the sash 16 (e.g., FIG. 29B). The end caps 160 include a profile that is operable to rotate in the pocket 90 of the fenestration unit 10 in a first direction without mechanical interference while being restrained in a second direction by mechanical interference. For example, the end caps 160 may include an arm 162 that is positioned in the pocket 90, the arm 162 being shaped to contact a first surface 90a to restrict rotation of the screen assembly 40 (see FIG. 26). The arm 162 may be positioned in the pocket 90 such that the arm contacts the first surface 90a when in a neutral position and restricts rotation in a first direction, whereas the arm 162 is not in contact with a second surface 90b, thus allowing the arm 162 to rotate in a second direction. In some embodiments, the second portion 166 of the arm 162 is spaced from the first surface 90a and the first portion 164 of the arm 160 is spaced from the second surface 90b of the pocket 90. This permits the end cap 160 and specifically the arm 162 to be rotated or maneuvered in one direction. For example, the first portion 164 of the arm 160 can be pushed towards the second surface 90b of the pocket 90 and the second portion 166 to be pushed towards the first surface 90a of the pocket 90, meaning the end cap can be pivoted or rotated to achieve this movement.

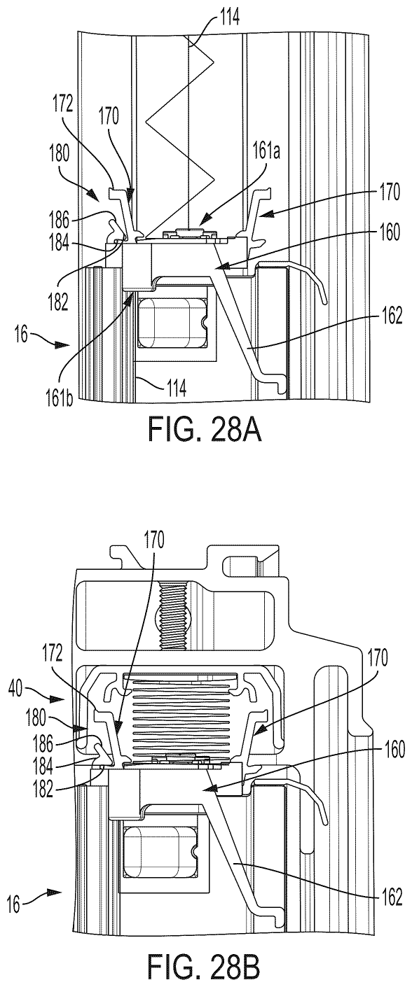

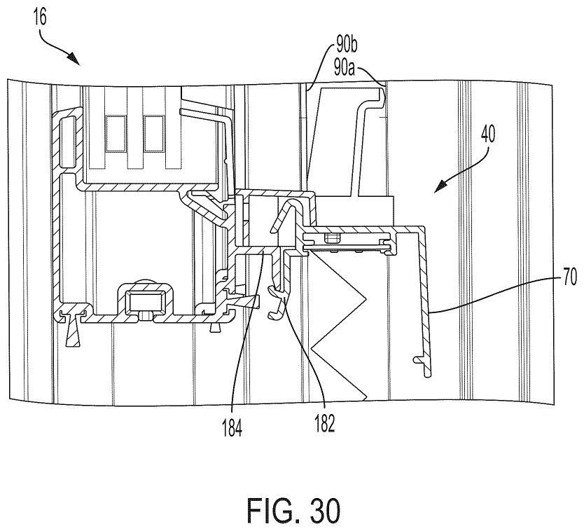

By pivoting or rotating the end cap 160, the screen assembly 40 can become disengaged from the sash 16. For example, in some embodiments, the screen assembly 40 includes the control bar 170, which can be engaged or manipulated by a user to cause pivoting or rotation of the end cap 160 for disengagement of the screen assembly 40 from the sash 40. The control bar 170 can extend from the screen assembly 40 to provide a user input portion 172 which the user can articulate to cause pivoting or rotating. The screen assembly 40 can further include coupling members 180 that are able to engage and disengage from the sash 16. For example, as illustrated in at least FIGS. 27, 28B and 29B, the coupling members 180 includes a lip 182 extending from the screen assembly 40 which is operable to contact a second lip 184 extending from the sash 16 (e.g., directly from the sash 16 or extending from a member that is coupled to the sash 16 such as a watershed feature 122). The two lips 182, 184 are operable to provide mechanical resistance and interference to maintain a positional relationship between the screen assembly 40 and the sash 16 when the two are in contact (e.g., when the sash 16 is moved to an open position, the lips 182, 184 are in contact such that the screen assembly 40 follows the sash). As illustrated in FIGS. 27-28B, the screen assembly 40 may be positioned in plane with the sash 16 (e.g., within the plane of travel). In other embodiments, the screen assembly 40 may be offset from the sash 16 (for example, as shown in FIG. 30). The lips 182, 184 may be oriented in a variety of ways to provide the mechanical resistance to allow the positional relationship between the sash 16 and the screen assembly 40. It is also understood that other components may provide some of the mechanical resistance to maintain the positional relationship between the sash 16 and the screen assembly 40 (e.g., the surfaces on the ends of the sash 16 and screen assembly 40 when the screen assembly 40 is in plane with the sash 16 may provide mechanical interference to push the screen assembly 40 when the sash 16 is being transitioned to a closed position).

Referring to FIG. 29B, the screen assembly 40 is illustrated being disengaged from the sash 16. In order to disengage the screen assembly 40 from the sash 16, the lips 182, 184 are repositioned such that the lips 182, 184 do not touch and are thus able to move past each other without contacting each other. For example, when the sash 16 and the screen assembly 40 are operable to travel in a first plane for opening and closing the sash 16 and screen assembly 40, one or both of the lips 182, 184 is articulated (e.g., translated or pivoted) in a direction out of the first plane so that as the sash 16 or screen assembly 40 is translated within the first plane, the lips 182, 184 are operable to slide past each other (clear each other, e.g., no contact or un-obstructive contact) such that the sash 16 and the screen assembly 40 can travel independent of each other. As previously disclosed, the screen assembly 40 may include a control bar 170 that is operable to pivot or rotate the screen assembly 40, which can allow the lips 182, 184 to travel past each other. It is understood that the screen assembly 40 can also decouple from the sash 16 in this embodiment by rotating the sash as previously described herein.

In some embodiments, the lips 182, 184 may include an angled surface 186 that facilitates reengagement of the lips 182 when the sash 14 and the screen assembly are transitioned back together (e.g., the angled surfaces 186 can be used to deflect one of the lips 182, 184 to allow for reengagement). The angled surfaces 186 can operate similar to as described with respect to FIG. 5. With respect to FIG. 30, in some embodiments where the screen assembly 40 is offset from the sash 14, the lips 182, 184 and angled surfaces 186 may be similar to those disclosed with respect to FIG. 5, a notable difference including at least that the screen assembly 40 is rotating away and not the sash 14 in order for the lips 182, 184 to clear each other.

In some embodiments, blockers 190 can be positioned at entry points through which insects could bypass the screen assembly 40 and sash 16. For example, blockers 190 may be positioned extending from the end caps 160 into the pockets 90. Blockers 190 can include brushes, foam plugs, or other resilient materials.

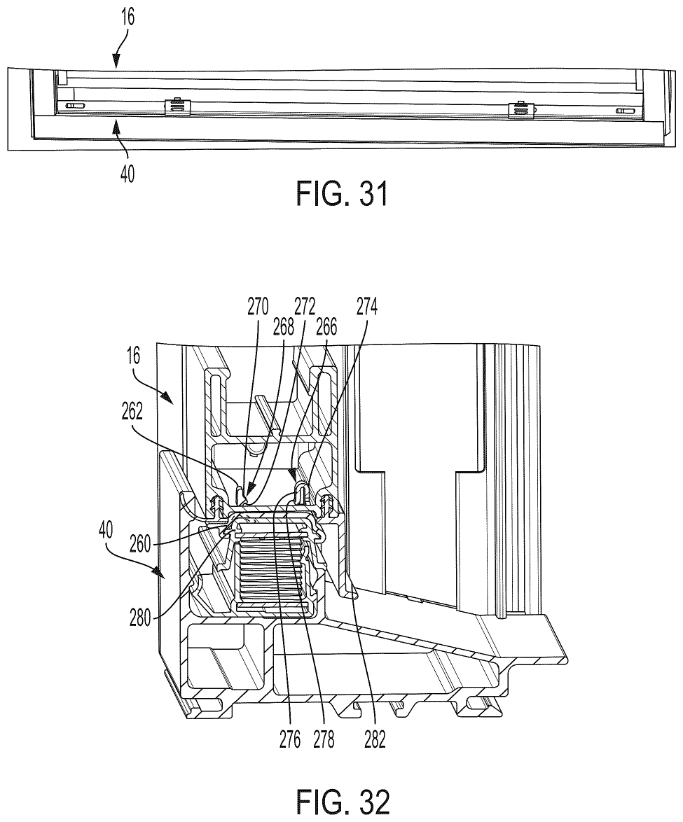

Referring now to FIG. 31-34, an embodiment of the sash 14 and screen assembly 40 is provided in which the screen assembly 40 includes a clip 260 operable to engage the sash 16. The clip 260 may extend directly from the screen assembly 40 or may be coupled to a portion of the screen assembly 40 (e.g., the housing 42), such as illustrated in FIG. 32. For example, the clip 260 may be coupled to a rail 280 on the housing 42 of the screen assembly 40. The clip 260 includes coupling members 262 operable to contact the sash 16 to provide a holding force between the screen assembly 40 and the sash 16. The coupling member 262 may include, for example, a first arm 264 and a second arm 266. The first arm 262 extends from the clip 260 and includes a protrusion 268 with a first surface 270 and a second surface 272. The first surface 270 is ramped or angled to facilitate coupling of the clip 260 with the sash 16 by deflecting the first arm 262 (via a surface of the sash 16) until the first surface 270 has passed beyond the corresponding surface of the sash 16 and the second surface 272 of the protrusion 268 is in contact with the sash 16. The second surface 272 is operable to provide mechanical resistance to decoupling of the sash 16 and the screen assembly 40. The second arm 268 may include a spring 274 that is operable to contact the sash 16 in order to provide a force against the sash 16 to position and maintain the second surface 272 of the first arm 266 against the sash 16. For example, the spring 274 is formed of a resilient material including a U-shaped portion 276. The U-shaped portion 276 includes an angle of less than 180 degrees such that the spring 274 is tapered. The spring 274 may further include an angled surface 278. The U-shaped portion and/or the angled surface are operable to provide a lateral force when contacting the sash 16 such that the first arm 262 maintains contact against the sash 16 and thus provides mechanical resistance against decoupling of the sash 16 and the screen assembly 40.

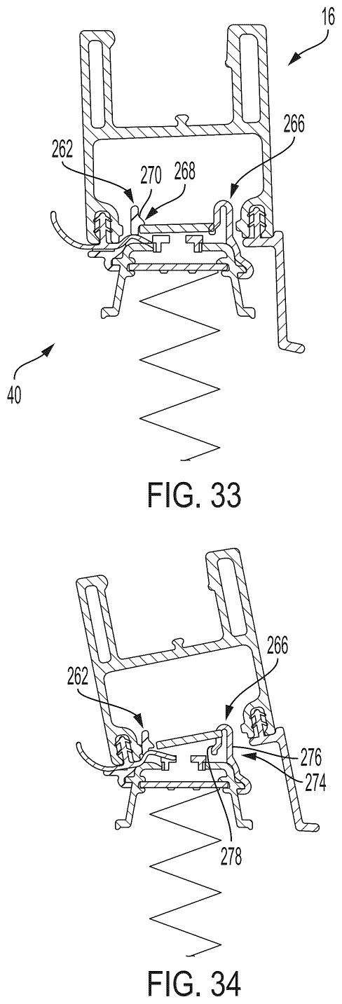

As illustrated in FIGS. 33-34, the screen assembly 40 may be disengaged from the sash 16 by rotating the sash 16 to decouple the clip 260. As the sash 16 is rotated, the spring 274 disengages from the sash 16 and the first arm 262 is operable to disengage from the sash 16. It is within the scope of the disclosure that the screen assembly 40 may also rotate, similar to as discussed with respect to FIGS. 26-30.

In some embodiments, the sash 16 includes coupling positions 282 at which the clip 260 is operable to couple to the sash 16. For example, the coupling positions 282 of the sash 16 may include apertures through which the portions of the clip extend 260 and which expose surfaces against which the clip 260 is positioned to provide mechanical resistance against decoupling of the sash 16 and the screen assembly. In some embodiments, the clip 260 is operable to transition or slide along the longitudinal length of the screen assembly 40 (e.g., along the rail 280). The clips 260 may be slid out of position with respect to the coupling positions 282 of the sash 16 in order to prevent coupling of the sash 16 and the screen assembly 40. This may be used during assembly, transport, installation, or otherwise to prevent coupling, which in these scenarios may for example, obstruct work, result in damage to the fenestration unit 10, and so forth.

Referring now to FIG. 20, the screen assembly 40 may include cords 114. The cords 114 may function to allow proportional and/or controlled deployment of the screen 50. The cords 114 may include a first cord 114A and a second cord 114B extending from the frame 12 and coupled to the housing 42 of the screen assembly 40, wherein the first and second cords 114A, 114B both extend along a shared length of a longitudinal length of the housing 42. Because the cords 114A and 114B cross along a shared length of the housing 42, the deployment of the screen assembly 40 is able to have a controlled release without disproportionate advancement of one screen assembly longitudinal side over the other longitudinal side. As previously discussed, the end caps 60 may include a gliding surface 66 that helps facilitate transitioning of the cords 114 from a vertical orientation to a horizontal orientation or from a horizontal orientation to a vertical orientation at the end caps 60. At those portions of the housing 42 of the screen assembly 40 near the gliding surface 66 of the end caps 60, the cord may be disposed along an exterior surface of the housing 42 and extend across at least a portion of the housing 42. It will be understood that any number of cords may be implemented in the various embodiments. Some examples of the number of cords that may be implemented in the disclosed embodiments include 2, 4, 6, 8, or 10 cords.

In various examples, the housing 42 further includes grommets 112 through which the cords 114 may extend. For example, the first and second housing members 44, 46 include grommets 112. The grommets 112 on the first housing member 44 allow for the cords 114 to extend into the interior space of the housing 42. The grommets 112 on the second housing member 46 allow for the cords to be coupled or fastened to the second hosing member 46. Because the cords 114 extend through the interior space of the housing 42 of the screen assembly 40, the screen 50 may also include features permitting the cords 114 to pass through the screen 50. The cords 114 may also provide stability to the screen 50 when deployed such that the screen 50 is maintained in a plane defined by the housing 42 of the screen assembly 40.

In order to further control or stabilize deployment of the screen 50, the housing 42 may include pleat restrictors 120, as seen in FIGS. 4, 5, 12, and 13. The pleat restrictors 120 may include a protrusion extending from the housing 42 extending partially into the interior space of the housing 42. The pleat restrictors 120 may be single protrusions spaced along the longitudinal length of the housing 42, or it may include single protrusions extending at least partially or fully across the longitudinal length of the housing 42. The pleat restrictors 120 are operable to prevent a pleat of a screen 50 to travel past the pleat restrictor 120 until sufficient force has been applied to the screen 50. Thus, the screen 50 is retained in the housing 42 until the edge of a pleat is able to travel past the pleat restrictor 120, which allows for the exposed portions of the screen 50 to remain relatively spread in order to increase visibility through the screen 50 when the screen 50 is deployed. The pleat restrictors 120 may also be offset from each other across the screen retention space 47. The pleat restrictors 120 may be positioned at various lengths/heights along the housing 42 in the direction in which the screen 50 extends when released from the housing 42. Thus, the pleat restrictors 120 may be staggered in order to allow controlled release of the screen 50.

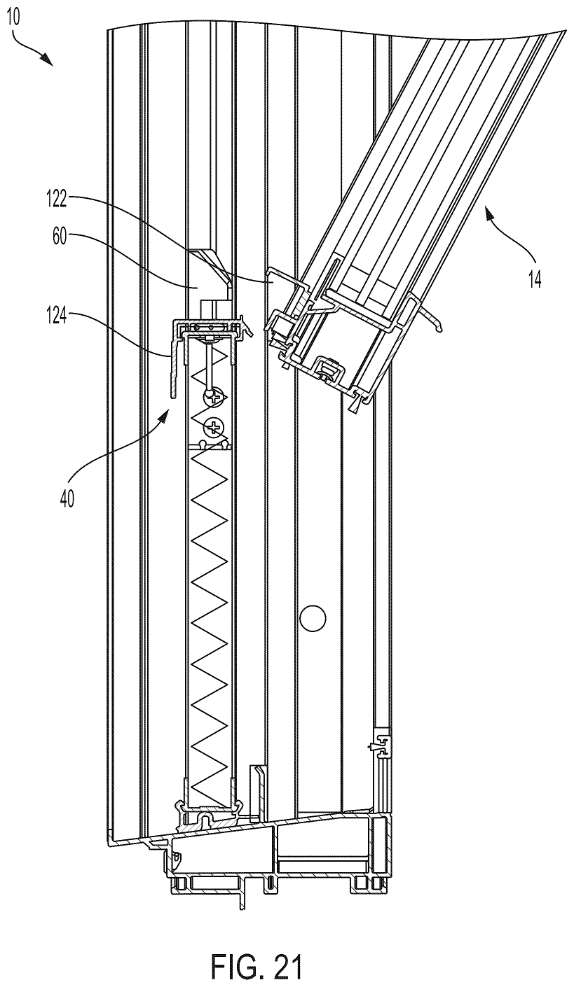

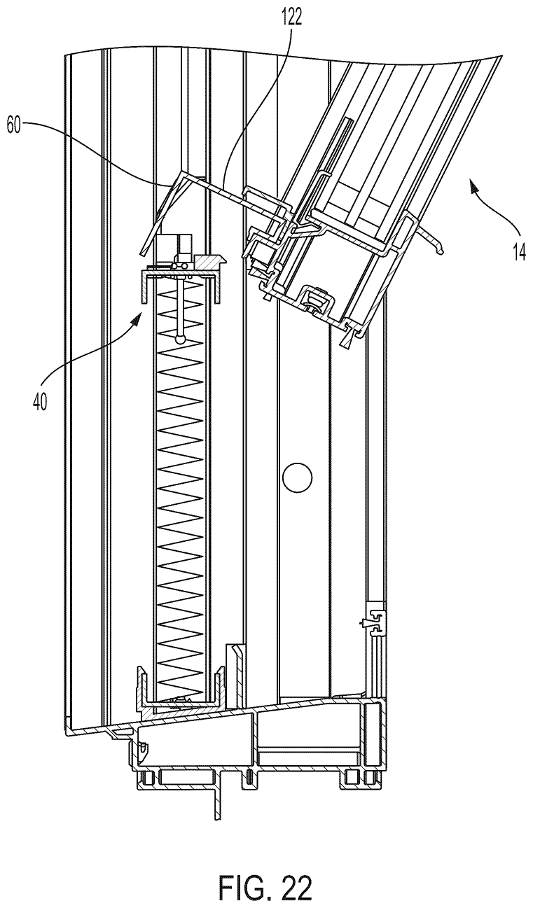

FIGS. 21 and 22 demonstrate various other embodiments of the components and configurations of those components (e.g., the end caps and the watershed features) with regard to the fenestration unit 10. None of the disclosure is meant to be limiting to a single specific embodiment, but various combinations of the features may be implemented within the various embodiments disclosed herein. For example, FIG. 21 provides an embodiment of fenestration unit 10 having a first watershed feature 122 and second watershed feature 124, where the first watershed feature extends from the sash 14 and the second watershed feature 124 extend from the screen assembly 40. FIG. 22 provides an embodiment of a watershed feature 122 extending from the sash 14 that is operable to shield both the intersection of the screen assembly 40 and the sash 14 and the first housing member 44. FIGS. 21 and 2 likewise demonstrate various embodiments of and configurations of the end caps 60. It is to be understood that such components may be used interchangeably where applicable.

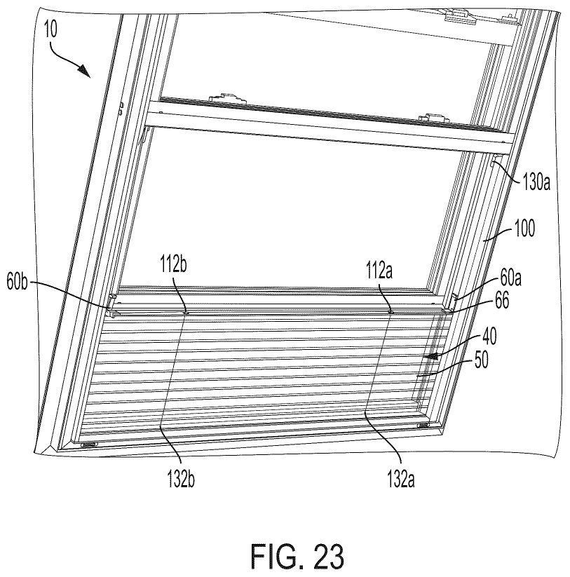

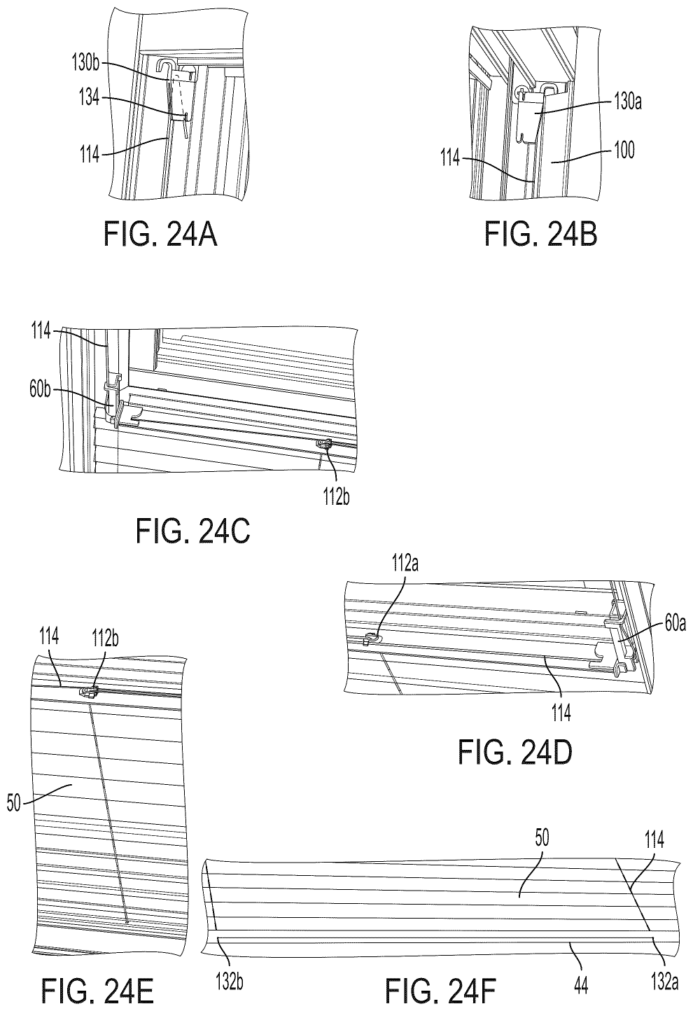

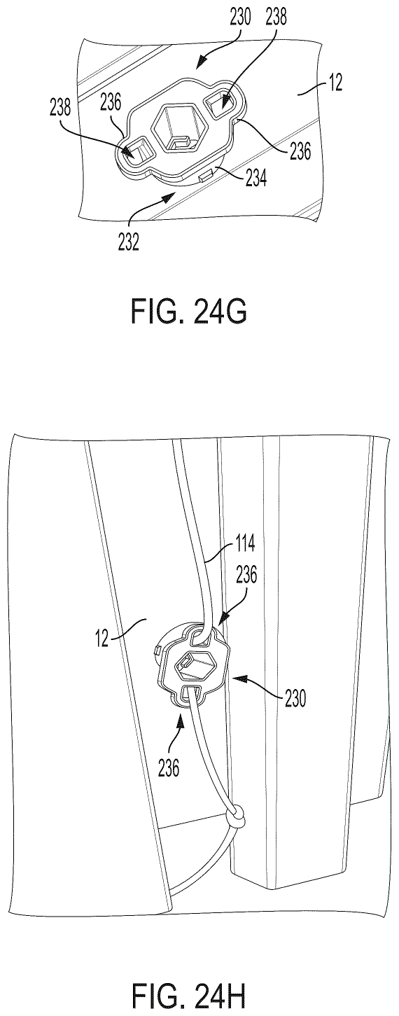

Referring now to FIGS. 23 and 24A-F, the cords 114 may be routed through at least portions of the screen assembly 40 and positioned relative to the fenestration unit 10 to support the screen assembly 40 at predetermined or desired positions. The following disclosed cord 114 and routing features may be considered a double support cord. For example, when a screen assembly 40 implements a double support cord 114, the routing of the cord 114 begins where the cord 114 is coupled to the fenestration unit 10. The cord 114 is knotted and the knotted portion of the cord 114 is captured in a first cord terminal 130a (see also FIG. 24B). The cord terminal 130 may be coupled to the fenestration unit 10 using various coupling techniques and features. For example, when the fenestration 10 includes an insert 100, for example as discussed with reference to FIGS. 11 and 12, the cord terminal 130 may be hooked over a top edge of the insert 100. The cord 114 may be routed in a first direction along the insert 100 to the first end cap 60a (see also FIG. 24D), the first end cap 60a including gliding surface 66 operable to allow about 90-degree turn (or any other appropriate angle of turn) in the cord 114 across the gliding surface 66. For example, the gliding surface 66 has low-friction surface forming an arc with a generous radius operable to allow the cord 114 to transition along that surface from the first direction to a second direction without causing excessive resistance and/or damage to the cord 114. The cord 114 is then routed past a first grommet 112a positioned on the screen assembly 40 and to a second grommet 112b, such that the cord 114 engages the second grommet 112b (see also FIGS. 24C, 24D, and 24E). Each of the grommets 112 can include a transition surface (not shown) about which the cord 114 may transition from the second direction to a third direction (it is recognized that the third direction in some embodiments it the same direction as the first direction). The transition surface may include a low-friction surface forming an arc with a generous radius operable to allow the cord 114 to transition along that surface without causing excessive resistance and/or damage to the cord 114. The cord is routed, via the transition surface through holes in the screen 50. The cord 114 is routed through a second hole 132b in the first housing member 44 (see also FIG. 24F). In some embodiments, the holes 132 do not include a transition feature for providing a smooth transition of the cord 114 between direction, thus increasing the friction and resistance of the cord 112 at the holes 132. In other embodiments, the first housing member 44 may include similar transition features as discussed previously along which the cord 114 is operable to transition from the third direction to a fourth direction, for example, via the holes 132. The cord 114 is then routed along the first housing member 44 and through a first hole 132a, the first hole 132a operable to transition the direction of the cord 114. Because the cord routing can be symmetrical, it is understood that the features and directions may also be inversely positioned. For example the first hole 132a is complementary to the second hole 132b, the first grommet 112a is complementary to the second grommet 112b, a second end cap 60b is complementary to the first end cap 60a, and a second cord terminal 130b is complementary to the first cord terminal 130a. Thus, the cord may be routed from the first hole 132a to the first grommet 112a (see also FIG. 24D), from the first grommet 112a past the second grommet 112b (thus the cord 114 overlap or crosses between the first and second grommets 112a, 112b) to the second end cap 60b (see also FIGS. 24C and 24D), and from the second end cap 60b to a second cord terminal 130b (see also FIG. 24A). The cord terminals 130 are operable to maintain the cord 114 at an appropriate tension. The cord terminals 130 may include slots 134 to clinch and wrap the cord 114 to ensure positive engagement.

The routing system described herein may provide stability of the first housing member 44 during operation, including when it is disconnected from the sash 14. Since cord 114 is operable to transition directions around sharp bends of the holes 132 on the first housing member 44, the first housing member 44 is able to be adjusted for level while the cord-hole interaction produces resistance to facilitate stability of the screen assembly 40.

Referring now to FIGS. 24G and 24H, an alternative cord terminal 230 is illustrated, the cord terminal operable to couple to the frame 12. For example, the frame 12 may include a recess 232 operable to receive at least a portion of the cord terminal 230. The cord terminal 232 may include a body 234 and a cord retainer 236 extending from the body 234. The cord retainer 236 may include, for example, apertures 238 through which the end of the cord 114 can be routed. In some embodiments, when the cord 114 is routed through the apertures 238, the cord 114 is positioned around at least a portion of the body 234. The cord terminal 230 is positioned in the recess 232 of the frame 12 and then can be engaged fully within the recess 232. When the cord terminal 230 is positioned but not fully engaged in the recess 232, the cord 114 may be adjusted to different lengths through the cord retainer 236 and apertures 238 (e.g., the cord 114 may slide through the apertures). Once the cord terminal 230 is translated into and fully engaged in the recess 232, the cord 114 is locked into that position until the cord terminal 230 is removed from the recess 232. Locking occurs because of the frictional force resulting on the cord 114 between both the frame 12 and the cord terminal 230 (e.g., positioned between or sandwiched between the frame 12 and cord terminal 230). Resistance to movement may also occur because of the change in direction of the cord 114 when the cord terminal 230 is fully engaged in the recess 232 (e.g., about a 90 degree turn at each aperture 238.

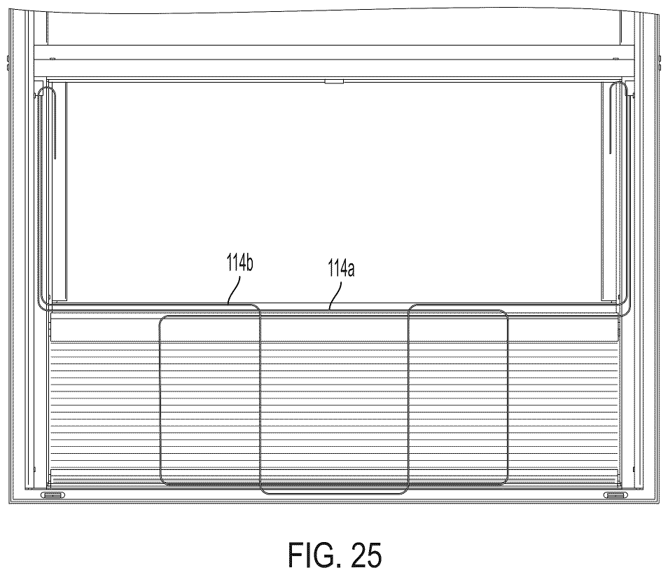

On wide vertical sliding windows or tall horizontal sliding windows, a secondary support cord 114b may be included. For example, FIG. 25 shows a fenestration unit 10 having a primary cord 114a and a secondary cord 114b. The routing of the secondary cord 114b, in some embodiments, does not need to cross over, because the primary cord 114a provides the leveling stability for the first housing member 44.

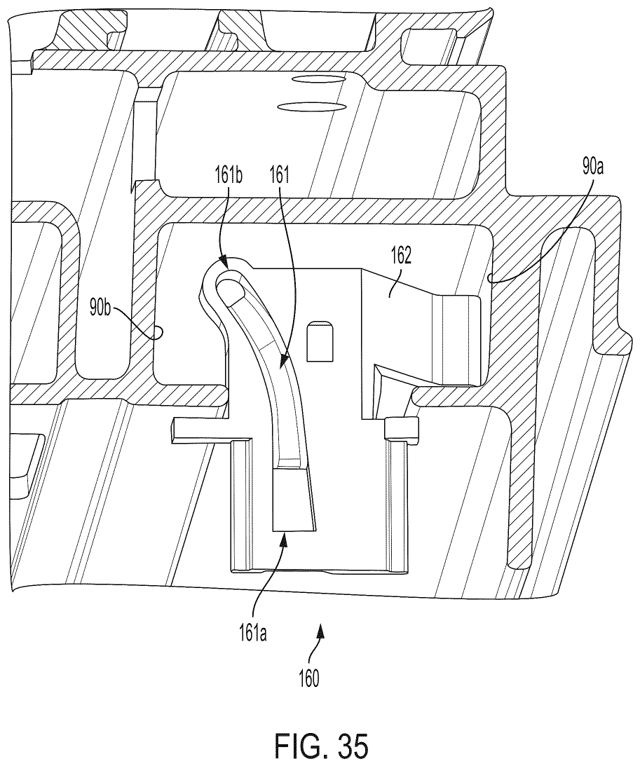

In some embodiments, the cords 114 and screen 50 may be mounted within the screen assembly 40 offset from a center of the screen assembly 40. For example, the portion of the cord 114 extending from the first housing members 44 and through the screen 50, the portion of the cord 114 extending from the screen assembly 40 pocket 90, or both may be may be offset from the lateral center of the screen assembly 40. The offset of the portion of the cord 114 that passes through the screen 50 and the portion of the cord 114 that in the jamb cavity creates a rotational force on the control bar. This rotational force provides proper positioning of the control bar 170 to insure proper engagement with the sash 16 (e.g., the engagement members 180), so as to keep the end caps 160 engaged in the pockets 90 and the lips 182, 184 of the engagement member 180 engaged with each other (see FIG. 28, for example). The endcaps 160 have relief on the opposite surface so that the control bar 170 can be pushed away from the engagement member 180 of the sash 16 to disengage the screen assembly 40 from the sash 16. This may be implemented in those embodiments in which the screen assembly 40 is rotated in order to facilitate decoupling of the screen assembly 40 from the sash 16. Referring to FIG. 35 the end cap 160 is shown with a cord routing 161. The cord 114 may be routed through the end cap 160 such that the cord 114 is positioned in a recess formed by the cord routing 161. The cord 114 may enter at a first position 161a and exit at a second position 161b. The first and second positions 161a, 161b can be spaced from each other such both longitudinally and laterally relative to the screen assembly 40. For example, the first position 161a may be at or near a longitudinal centerline whereas the second position 161b may be positioned laterally spaced from the longitudinal centerline. As tension is applied across the cord 114, the offset of the second position 161b causes a torsional force to be applied to the screen assembly 40. The torsional force helps maintain the arm 160 against the first surface 90a of the pocket 90 and accordingly in the neutral position. As previously discussed, the screen assembly 40 can be deflected away from the neutral position by applying a force to the control bar 170, and in this embodiment, the force being sufficient to overcome the torsional force of the cords 114.

A method of providing a screen assembly on a fenestration unit is provided, wherein the fenestration unit may include a frame having a first portion, a second portion opposite the first portion, a first jamb extending between the first portion and the second portion, and a second jamb opposite the first jamb and extending between the first portion and the second portion, wherein the first jamb and the second jamb each include a first pocket, and a sash including a first rail, a second rail opposite the first rail, a first stile extending between the first and second rails, and a second stile opposite the first stile and extending between the first and second rails. The first and second stiles may be positioned in the first pocket of the first and second jamb such that the sash may translate within the first pocket relative to the frame. The method may include engaging end caps of a screen assembly with the first pocket of the frame, coupling a first housing member of the screen assembly to the first portion of the frame, such that when the sash is translated between an open and a closed position, the second housing member remains positioned with the first portion of the frame, and releasably coupling a second housing member of the screen assembly to the sash of the fenestration unit such that a catch element of the first housing member engages with a wash lock of the sash.

The inventive concepts hereby addressed have been described above both generically and with regard to specific examples. It will be apparent to those skilled in the art that various modifications and variations can be made in the examples without departing from the scope of the disclosure. Likewise, the various components discussed in the examples are combinable. Thus, it is intended that the examples be viewed collectively, as a whole, as also intimating various modifications and variations of those specific examples.

1.-7. (canceled)

8. A fenestration unit comprising:
a frame having a first portion, a second portion opposite the first portion, a first jamb extending between the first portion and the second portion, and a second jamb opposite the first jamb and extending between the first portion and the second portion, wherein the first jamb and the second jamb each include a first pocket;
a sash including a first rail, a second rail opposite the first rail, a first stile extending between the first and second rails, and a second stile opposite the first stile and extending between the first and second rails, wherein the first and second stiles include extensions positioned in each first pocket of the first and second jamb such that the extensions are configured to translate within each corresponding first pocket relative to the frame; and
a screen assembly operable to extend between the first portion of the frame and the first rail of the sash, the screen assembly including a housing having a first housing member and a second housing member maintained between the first jamb and the second jamb of the frame, wherein the housing forms a screen retention space between the first and second housing members when the screen assembly is in a closed position, a pleated screen positioned between the first and second housing members when the screen assembly is in the closed position, wherein the pleated screen includes a first end coupled to the first housing member and a second end coupled to the second housing member, and a catch element configured to releasably engage with the first rail of the sash.

9. The fenestration unit of claim 8, further comprising end caps positioned at first and second longitudinal ends of the housing.

10. The fenestration unit of claim 9, further comprising a wash lock extending from the sash, wherein the catch element is positioned on the end caps, and wherein the wash lock is configured to releasably engage the catch element.

11. The fenestration unit of claim 10, wherein each of the end caps are positioned in the first pocket of the first and second jambs, respectively.

12. The fenestration unit of claim 8, wherein the catch element is positioned on the housing such that the housing engages with the first rail of the sash.

13. The fenestration unit of claim 8, wherein the screen assembly is engaged with the first pocket of the frame.

14. The fenestration unit of claim 8, wherein the first and second jambs of the frame further include a second pocket, wherein the screen assembly is engaged with the second pocket of the frame.

15. The fenestration unit of claim 14, wherein a portion of the screen extends out from the housing into the second pocket of the frame.

16. The fenestration unit of claim 15, wherein the portion of the screen extending out from the housing includes longitudinal slits.

17. The fenestration unit of claim 14, further comprising an insert couplable to the first portion of the frame to form a recess, wherein the first housing member of the screen assembly is configured to be positioned in the recess formed by the insert and the first portion of the frame.

18. The fenestration unit of claim 8, further comprising a first cord portion and a second cord portion extending from the frame and coupled to the housing of the screen assembly, wherein the first and second cord portions both extend along a shared length of a longitudinal length of the housing.

19. The fenestration unit of claim 8, further comprising:
second sash, wherein the frame includes a second pocket with which the second sash is engaged and in which the second sash is operable to translate relative to the frame;
a second screen assembly operable to extend between the second portion of the frame and the second sash.

20. A method of providing a screen assembly on a fenestration unit, wherein the fenestration unit includes a frame defining a pocket, and a sash engaged with the pocket of the frame such that the sash is configured to translate along the pocket relative to the frame, the method comprising:
engaging end caps of a screen assembly with the pocket of the frame;
coupling a first housing member of the screen assembly to the frame, such that when the sash is translated between an open and a closed position, the second housing member remains positioned with the first portion of the frame; and
releasably coupling a second housing member of the screen assembly to the sash of the fenestration unit such that a catch element of the first housing member engages with a wash lock of the sash.
